(19) United States
(12) Patent Application Publication
(10) Pub. No.: US 2026/0231141 A1
(43) Pub. Date: Aug. 6, 2026

(54) SCHEDULING OF SENSING OPERATION AND COMMUNICATION OPERATION

(71) Applicant: Huawei Technologies Co., Ltd., Shenzhen (CN)

(72) Inventors: Liqing Zhang, Ottawa (CA); Jianglei Ma, Ottawa (CA)

(21) Appl. No.: 19/636,749

(22) Filed: Apr. 1, 2026

Related U.S. Application Data
(63) Continuation of application No. PCT/CN2024/094818, filed on May 23, 2024.
(60) Provisional application No. 63/587,749, filed on Oct. 4, 2023.

(51) Int. Cl. H04W 72/12; H04W 72/232

(52) U.S. Cl. CPC H04W 72/12; H04W 72/232

(57) ABSTRACT

Example embodiments relate to scheduling of a sensing operation and/or a communication operation. In an aspect, a first device transmits a first-stage DCI for indicating that at least one of a sensing operation or a communication operation to be scheduled. Also, the first device transmits a second-stage DCI for scheduling the at least one of the sensing operation or the communication operation.

### CROSS-REFERENCE TO RELATED APPLICATIONS

This application is a continuation of International Patent Application PCT/CN2024/094818, filed on May 23, 2024, which claims the benefit of U.S. Patent Application No. 63/587,749, filed on Oct. 4, 2023. The entire contents of these disclosures are incorporated herein by reference.

### FIELD

Example embodiments of the present disclosure generally relate to the field of communication and in particular, to methods, devices, apparatuses and a computer readable storage medium for scheduling of a sensing operation and a communication operation.

### BACKGROUND

With the development of communication technology, future wireless network such as 6G network may support an important feature: integrated sensing and communication (ISAC). A communication operation is used to provide transmissions of data or control information between user equipment (UE) and network (e.g., base station), between UEs and/or between base stations. A sensing operation is used to provide a measurement via a sensing signal, and the measurement may include an estimation on distance, ranging, size and/or orientation of a UE or an object target. The communication signals and sensing signals may or may not be similar in terms of, for example, carrier frequency band, component carrier, signal bandwidth, or signal waveform, etc. However, various technologies related to the sensing operations and/or the communication operations may need to be further improved or optimized, so as to enhance sensing performance, communication performance, or both.

### SUMMARY

In general, example embodiments of the present disclosure provide a solution for scheduling of a sensing operation and/or a communication operation.

In a first aspect, there is provided a method. The method comprises transmitting a first-stage downlink control information (DCI) for indicating at least one of a sensing operation or a communication operation to be scheduled; and transmitting a second-stage DCI for scheduling the at least one of the sensing operation or the communication operation. As such, the scheduling of a sensing operation and/or a communication operation is simplified. Therefore, the overhead for the sensing operation and/or the communication operation is reduced.

In some embodiments, the first-stage DCI may comprise at least one of the following information for the at least one of the sensing operation or the communication operation: at least one carrier frequency band; a duplex mode, at least one component carrier associated with at least one channel bandwidth, at least one subcarrier spacing to be used, an antenna configuration, a frequency resource assignment for the second-stage DCI, a time resource assignment for the second-stage DCI, an indication of a physical downlink control channel (PDCCH) in a control resource set (CORESET) for carrying the second-stage DCI, at least one reference frequency domain location, at least one reference time location, at least one sensing type, a transmission or reception direction in a sensing operation, a set of reserved time or frequency resources, a resource reservation period, a demodulation reference signal (DMRS) pattern for the communication operation, a sensing signal waveform for the sensing operation, a sensing sequence configuration, a DCI format of the second-stage DCI, a number of at least one DMRS port, an antenna port configuration, a modulation and coding scheme (MCS), an indicator of a MCS table, an indication of one of the sensing operation or the communication operation for which rate matching is to be performed in case of resource usage conflict between the sensing operation and the communication operation, or an indication on at least one quasi co-located (QCLed) reference signal (RS). In this way, which operation(s) to be scheduled may be indicated.

In some embodiments, two or more bits may be used for indicating the at least one of the sensing operation or the communication operation to be scheduled. In this way, which operation(s) to be scheduled may be indicated by the two or more bits.

In some embodiments, a first combination of values of the two or more bits may indicate the sensing operation to be scheduled, a second combination of values of the two or more bits indicates the communication operation to be scheduled, and a third combination of values of the two or more bits may indicate both the sensing operation and the communication operation to be scheduled. In this way, at least one of the sensing operation or the communication operation to be scheduled may be indicated by the two or more bits.

In some embodiments, further combinations of values of the two or more bits indicate at least one of the following: system information update, a type of warning, a skipping notification on a message, a priority indication on resource usage for at least one of the sensing operation or the communication operation, an indication of a quasi-collocated reference signal, an indication of a transceiver type, a switching indication of the transceiver type, an activation indication of configured or reserved resource usage, or a de-activation indication of the configured or reserved resource usage. In this way, special signaling or notification may additionally be indicated by the two or more bits.

In some embodiments, the at least one sensing type may comprise at least one of the following: mono-static sensing between a transmitter and a receiver in a user equipment (UE), bi-static sensing between a UE and a base station (BS) or between a UE and a UE, bi-static sensing among a UE, a sensing target and a BS, or among a UE, a sensing target and a UE, or multi-static sensing comprising a sensing group configuration for bi-static sensing from more than two participant nodes. In this way, different sensing types may be indicated by the first-stage DCI.

In some embodiments, the second-stage DCI may comprise at least one of the following information for the at least one of the sensing operation or the communication operation: at least one carrier frequency band, a duplex mode, at least one component carrier associated with at least one channel bandwidth, at least one subcarrier spacing to be used, an antenna configuration, a frequency resource assignment, a time resource assignment, at least one reference frequency domain location, at least one reference time location, at least one sensing type, a transmission or reception direction in a sensing operation, a set of reserved time or frequency resources, a resource reservation period, a DMRS pattern for the communication operation, a sensing signal waveform for the sensing operation, a sensing sequence configuration, a number of at least one DMRS port, an antenna port configuration, a MCS, an indicator of a MCS table, an indication of one of the sensing operation or the communication operation for which rate matching is to be performed in case of resource usage conflict between the sensing operation and the communication operation, an indication on at least one QCLed RS, a time hopping pattern, a frequency hopping pattern, a hybrid automatic repeat request (HARQ) process identity (ID), a new data indicator, an indication that more sensing operations are required, at least one redundancy version for communication, at least one repeatable sensing resource and pattern, at least one zone ID, a communication range requirement, a sensing range requirement, a priority of resource usage of one of the sensing operation or the communication operation in case of resource usage conflict between the sensing operation and the communication operation, rate matching for one of the sensing operation or the communication operation, a request for channel state information (CSI) report, or a cast type. In this way, configuration of time-frequency resource and associated parameters for the sensing operation or the communication operation may be indicated by the second-stage DCI.

In some embodiments, the cast type may comprise at least one of the following: unicast, multi-cast, or broadcast. In this way, different cast types may be indicated by the second-stage DCI.

In some embodiments, the sensing operation may be a sidelink sensing operation, and at least one of the first-stage DCI or the second-stage DCI may comprise at least one of a sensing source ID or a sensing target ID in the sidelink sensing operation. In this way, the sensing source ID or the sensing target ID may be provided for the sidelink sensing operation.

In some embodiments, the first-stage DCI may indicate both the sensing operation and the communication operation to be scheduled, and the sensing operation and the communication operation may be time-aligned and synchronized with a time reference point. In this way, downlink (DL) or uplink (UL) synchronization, time advanced (TA) adjustment may be performed.

In some embodiments, the first-stage DCI and the second-stage DCI may be carried by two control channels, and the two control channels may be located in a same CORESET or two different CORESETs. In this way, the first-stage DCI and the second-stage DCI may be carried flexibly.

In some embodiments, the first-stage DCI and the second-stage DCI may be time division multiplexed, frequency division multiplexed, or multiplexed in both time domain and frequency domain. In this way, the first-stage DCI and the second-stage DCI may be multiplexed in several manners.

In some embodiments, the first-stage DCI may be carried by a control channel, and the second-stage DCI may be carried by a data channel. In this way, the second-stage DCI may be carried in several manners.

In some embodiments, the method may comprise transmitting configuration information indicating a set of configurations for the at least one of the sensing operation or the communication operation, wherein the first-stage DCI and the second-stage DCI indicates at least one configuration for the at least one of the sensing operation or the communication operation among the set of configurations. In this way, the overhead may be reduced.

In some embodiments, the set of configurations may be transmitted by a radio resource control (RRC) message or a medium access control (MAC) control element (MAC CE). In this way, the set of configurations may be transmitted in several manners.

In a second aspect, there is provided a method. The method comprising: receiving a first-stage downlink control information (DCI) indicating that at least one of a sensing operation or a communication operation is to be scheduled; and receiving a second-stage DCI for scheduling the at least one of the sensing operation or the communication operation. As such, the scheduling of a sensing operation and a communication operation is simplified. Therefore, the overhead for the sensing operation and the communication operation is reduced.

In some embodiments, the first-stage DCI may comprise at least one of the following information for the at least one of the sensing operation or the communication operation: at least one carrier frequency band, a duplex mode, at least one component carrier associated with at least one channel bandwidth, at least one subcarrier spacing to be used, an antenna configuration, a frequency resource assignment for the second-stage DCI, a time resource assignment for the second-stage DCI, an indication of a physical downlink control channel (PDCCH) in a control resource set (CORESET) for carrying the second-stage DCI, at least one reference frequency domain location, at least one reference time location, at least one sensing type, a transmission or reception direction in a sensing operation, a set of reserved time or frequency resources, a resource reservation period, a demodulation reference signal (DMRS) pattern for the communication operation, a sensing signal waveform for the sensing operation, a sensing sequence configuration, a DCI format of the second-stage DCI, a number of at least one DMRS port, an antenna port configuration, a modulation and coding scheme (MCS), an indicator of a MCS table, an indication of one of the sensing operation or the communication operation for which rate matching is to be performed in case of resource usage conflict between the sensing operation and the communication operation, or an indication on at least one quasi co-located (QCLed) reference signal (RS). In this way, which operation(s) to be scheduled may be indicated.

In some embodiments, two or more bits may be used for indicating the at least one of the sensing operation or the communication operation to be scheduled. In this way, which operation(s) to be scheduled may be indicated by the two or more bits.

In some embodiments, a first combination of values of the two or more bits may indicate the sensing operation to be scheduled, a second combination of values of the two or more bits may indicate the communication operation to be scheduled, and a third combination of values of the two or more bits may indicate both the sensing operation and the communication operation to be scheduled. In this way, at least one of the sensing operation or the communication operation to be scheduled may be indicated by the two or more bits.

In some embodiments, further combinations of values of the two or more bits may indicate at least one of the following: system information update, a type of warning, a skipping notification on a message, a priority indication on resource usage for at least one of the sensing operation or the communication operation, an indication of a quasi-collocated reference signal, an indication of a transceiver type, a switching indication of the transceiver type, an activation indication of configured or reserved resource usage, or a de-activation indication of the configured or reserved resource usage. In this way, special signaling or notification may additionally be indicated by the two or more bits.

In some embodiments, the at least one sensing type may comprise at least one of the following: mono-static sensing between a transmitter and a receiver in a user equipment (UE), bi-static sensing between a UE and a base station (BS) or between a UE and a UE, bi-static sensing among a UE, a sensing target and a BS, or among a UE, a sensing target and a UE, or multi-static sensing comprising a sensing group configuration for bi-static sensing from more than two participant nodes. In this way, different sensing types may be indicated by the first-stage DCI.

In some embodiments, the second-stage DCI may comprise at least one of the following information for the at least one of the sensing operation or the communication operation: at least one carrier frequency band, a duplex mode, at least one component carrier associated with at least one channel bandwidth, at least one subcarrier spacing to be used, an antenna configuration, a frequency resource assignment, a time resource assignment, at least one reference frequency domain location, at least one reference time location, at least one sensing type, a transmission or reception direction in a sensing operation, a set of reserved time or frequency resources, a resource reservation period, a DMRS pattern for the communication operation, a sensing signal waveform for the sensing operation, a sensing sequence configuration, a number of at least one DMRS port, an antenna port configuration, a MCS, an indicator of a MCS table, an indication of one of the sensing operation or the communication operation for which rate matching is to be performed in case of resource usage conflict between the sensing operation and the communication operation, an indication on at least one QCLed RS, a time hopping pattern, a frequency hopping pattern, a hybrid automatic repeat request (HARQ) process identity (ID), a new data indicator, an indication that more sensing operations are required, at least one redundancy version for communication, at least one repeatable sensing resource and pattern, at least one zone ID, a communication range requirement, a sensing range requirement, a priority of resource usage of one of the sensing operation or the communication operation in case of resource usage conflict between the sensing operation and the communication operation, rate matching for one of the sensing operation or the communication operation, a request for channel state information (CSI) report, or a cast type. In this way, configuration of time-frequency resource and associated parameters for the sensing operation or the communication operation may be indicated by the second-stage DCI.

In some embodiments, the cast type may comprise at least one of the following: unicast, multi-cast, or broadcast. In this way, different cast types may be indicated by the second-stage DCI.

In some embodiments, the sensing operation may be a sidelink sensing operation, and at least one of the first-stage DCI or the second-stage DCI may further comprise at least one of a sensing source ID or a sensing target ID in the sidelink sensing operation. In this way, the sensing source ID or the sensing target ID may be provided for the sidelink sensing operation.

In some embodiments, the first-stage DCI may indicate both the sensing operation and the communication operation are to be scheduled, and the sensing operation and the communication operation may be time-aligned and synchronized with a time reference point. In this way, downlink (DL) or uplink (UL) synchronization, time advanced (TA) adjustment may be performed.

In some embodiments, the first-stage DCI and the second-stage DCI may be carried by two control channels, and the two control channels may be located in a same CORESET or two different CORESETs. In this way, the first-stage DCI and the second-stage DCI may be carried flexibly.

In some embodiments, the first-stage DCI and the second-stage DCI may be time division multiplexed, frequency division multiplexed, or multiplexed in both time domain and frequency domain. In this way, the first-stage DCI and the second-stage DCI may be multiplexed in several manners.

In some embodiments, the first-stage DCI may be carried by a control channel, and the second-stage DCI may be carried by a data channel. In this way, the second-stage DCI may be carried in several manners.

In some embodiments, the method may comprise receiving configuration information indicating a set of configurations for the at least one of the sensing operation or the communication operation, wherein the first-stage DCI and the second-stage DCI indicates at least one configuration for the at least one of the sensing operation or the communication operation among the set of configurations. In this way, the overhead may be reduced.

In some embodiments, the set of configurations may be received by a radio resource control (RRC) message or a medium access control (MAC) control element (MAC CE). In this way, the set of configuration may be received in several manners.

In some embodiments, the method may comprise performing at least one of the following after receiving the first-stage DCI and the second-stage DCI: communicating with a BS, communicating with at least one other UE, performing mono-static sensing in an indicated transmission or reception direction, performing bi-static sensing between a UE and a BS or between a UE and a UE, performing bi-static sensing in an indicated transmission or reception direction among a UE, a sensing target and a BS, or among a UE, a sensing target and a UE, performing multi-static sensing in an indicated transmission or reception direction among a UE, a sensing target and a BS, or among a UE, a sensing target and a UE, wherein a sensing source ID or a sensing reception ID may be included in the at least one of the first-stage DCI or the second-stage DCI. In this way, the sensing operation or the communication operation may be scheduled based on the first-stage DCI and the second-stage DCI.

In a third aspect, there is provided a method. The method comprising: transmitting a first-stage downlink control information (DCI) for indicating a sensing operation and a communication operation to be scheduled; and transmitting a second-stage DCI for scheduling the sensing operation and the communication operation. As such, the scheduling of a sensing operation and a communication operation is simplified. Therefore, the overhead for the sensing operation and the communication operation is reduced.

In some embodiments, the first-stage DCI may further comprise a DCI format of the second-stage DCI. In this way, the DCI format of the second-stage DCI may be indicated.

In some embodiments, the second-stage DCI may comprise at least one of the following information for the sensing operation: a frequency resource assignment, a time resource assignment, a transmission or reception direction, a time hopping pattern, a frequency hopping pattern, a sensing signal waveform, at least one carrier frequency band, at least one bandwidth part, or at least one sensing type. In this way, configuration of time-frequency resource and associated parameters for the sensing operation may be indicated by the second-stage DCI.

In some embodiments, the at least one sensing type may comprise at least one of the following: mono-static sensing between a transmitter and a receiver in a user equipment (UE); bi-static sensing between a UE and a base station (BS) or between a UE and a UE; bi-static sensing among a UE, a sensing target and a BS, or among a UE, a sensing target and a UE; or multi-static sensing comprising a sensing group configuration for bi-static sensing from more than two participant nodes. In this way, different sensing types may be indicated by the second-stage DCI.

In some embodiments, the second-stage DCI may comprise at least one of the following information for the communication operation: a frequency resource assignment, a time resource assignment, a transmission or reception direction, a time hopping pattern, a frequency hopping pattern, a signal waveform, at least one carrier frequency band, or at least one bandwidth part. In this way, configuration of time-frequency resource and associated parameters for the communication operation may be indicated by the second-stage DCI.

In some embodiments, the sensing operation may be a sidelink sensing operation, and at least one of the first-stage DCI or the second-stage DCI may comprise at least one of a sensing source ID or a sensing target ID in the sidelink sensing operation. In this way, the sensing source ID or the sensing target ID may be provided for the sidelink sensing operation.

In some embodiments, one of the first-stage DCI or the second-stage DCI may further comprise at least one of the following: an indication of one of the sensing operation or the communication operation for which rate matching is to be performed in case of resource usage conflict between the sensing operation and the communication operation, a priority of resource usage of one of the sensing operation or the communication operation in case of resource usage conflict between the sensing operation and the communication operation, an indication on at least one quasi co-located (QCLed) reference signal (RS), a configuration for split beams or shared beams, or a configuration for split antennas. In this way, additional information may be flexibly carried by the first-stage DCI and the second-stage DCI.

In some embodiments, the sensing operation and the communication operation may be time-aligned and synchronized with a time reference point. In this way, downlink (DL) or uplink (UL) synchronization, time advanced (TA) adjustment may be performed.

In some embodiments, the first-stage DCI and the second-stage DCI may be time division multiplexed, frequency division multiplexed, or multiplexed in both time domain and frequency domain. In this way, the first-stage DCI and the second-stage DCI may be multiplexed in several manners.

In some embodiments, the method may comprise transmitting configuration information indicating a set of configurations for the sensing operation and the communication operation, wherein the first-stage DCI and the second-stage DCI indicates at least one configuration for the sensing operation and the communication operation among the set of configurations. In this way, the overhead may be reduced.

In some embodiments, the set of configurations may be transmitted by a radio resource control (RRC) message or a medium access control (MAC) control element (MAC CE). In this way, the set of configurations may be transmitted in several manners.

In a fourth aspect, there is provided a method. The method comprising: receiving a first-stage downlink control information (DCI) for indicating a sensing operation and a communication operation to be scheduled, and receiving a second-stage DCI for scheduling the sensing operation and the communication operation. As such, the scheduling of a sensing operation and a communication operation is simplified. Therefore, the overhead for the sensing operation and the communication operation is reduced.

In some embodiments, the first-stage DCI may further comprise a DCI format of the second-stage DCI. In this way, the DCI format of the second-stage DCI may be indicated.

In some embodiments, the second-stage DCI may comprise at least one of the following information for the sensing operation: a frequency resource assignment, a time resource assignment, a transmission or reception direction, a time hopping pattern, a frequency hopping pattern, a sensing signal waveform, at least one carrier frequency band, at least one bandwidth part, or at least one sensing type. In this way, configuration of time-frequency resource and associated parameters for the sensing operation may be indicated by the second-stage DCI.

In some embodiments, the at least one sensing type may comprise at least one of the following: mono-static sensing between a transmitter and a receiver in a user equipment (UE), bi-static sensing between a UE and a base station (BS) or between a UE and a UE, bi-static sensing among a UE, a sensing target and a BS, or among a UE, a sensing target and a UE, or multi-static sensing comprising a sensing group configuration for bi-static sensing from more than two participant nodes. In this way, different sensing types may be indicated by the second-stage DCI.

In some embodiments, the second-stage DCI may comprise at least one of the following information for the communication operation: a frequency resource assignment, a time resource assignment, a transmission or reception direction, a time hopping pattern, a frequency hopping pattern, a signal waveform, at least one carrier frequency band, or at least one bandwidth part. In this way, configuration of time-frequency resource and associated parameters for the communication operation may be indicated by the second-stage DCI.

In some embodiments, the sensing operation may be a sidelink sensing operation, and at least one of the first-stage DCI or the second-stage DCI may comprise at least one of a sensing source ID or a sensing target ID in the sidelink sensing operation. In this way, the sensing source ID or the sensing target ID may be provided for the sidelink sensing operation.

In some embodiments, one of the first-stage DCI or the second-stage DCI may further comprise at least one of the following: an indication of one of the sensing operation or the communication operation for which rate matching is to be performed in case of resource usage conflict between the sensing operation and the communication operation, a priority of resource usage of one of the sensing operation or the communication operation in case of resource usage conflict between the sensing operation and the communication operation, an indication on at least one quasi co-located (QCLed) reference signal (RS), a configuration for split beams or shared beams, or a configuration for split antennas. In this way, additional information may be flexibly carried by the first-stage DCI and the second-stage DCI.

In some embodiments, the sensing operation and the communication operation may be time-aligned and synchronized with a time reference point. In this way, downlink (DL) or uplink (UL) synchronization, time advanced (TA) adjustment may be performed.

In some embodiments, the first-stage DCI and the second-stage DCI may be time division multiplexed, frequency division multiplexed, or multiplexed in both time domain and frequency domain. In this way, the first-stage DCI and the second-stage DCI may be multiplexed in several manners.

In some embodiments, the method may comprise receiving configuration information indicating a set of configurations for the sensing operation and the communication operation, wherein the first-stage DCI and the second-stage DCI indicates at least one configuration for the sensing operation and the communication operation among the set of configurations. In this way, the overhead may be reduced.

In some embodiments, the set of configurations may be received by a radio resource control (RRC) message or a medium access control (MAC) control element (MAC CE). In this way, the set of configurations may be transmitted in several manners.

In some embodiments, the method may further comprise performing at least one of the following after receiving the first-stage DCI and the second-stage DCI: communicating with a BS, communicating with at least one other UE, performing mono-static sensing in an indicated transmission or reception direction, performing bi-static sensing between a UE and a BS or between a UE and a UE, performing bi-static sensing in an indicated transmission or reception direction among a UE, a sensing target and a BS, or among a UE, a sensing target and a UE, performing multi-static sensing in an indicated transmission or reception direction among a UE, a sensing target and a BS, or among a UE, a sensing target and a UE, wherein a sensing source ID or a sensing reception ID may be included in the at least one of the first-stage DCI or the second-stage DCI. In this way, the sensing operation or the communication operation may be scheduled based on the first-stage DCI and the second-stage DCI.

In a fifth aspect, there is provided a method. The method comprising: transmitting configuration information indicating a set of configurations for sensing operations; and transmitting a dedicated downlink control information (DCI) scheduling a sensing operation and indicating, among the set of configurations, at least one configuration for the sensing operation. As such, the scheduling of a sensing operation is simplified. Therefore, the overhead for the sensing operation is reduced.

In some embodiments, the at least one configuration may comprise at least one of the following information: at least one carrier frequency band, a duplex mode, at least one component carrier associated with at least one channel bandwidth, at least one subcarrier spacing to be used, an antenna configuration, a frequency resource assignment, a time resource assignment, at least one reference frequency domain location, at least one reference time location, at least one sensing type, a transmission or reception direction in a sensing operation, a set of reserved time or frequency resources, a resource reservation period, a sensing signal waveform, a sensing sequence configuration, a number of at least one DMRS port, an antenna port configuration, a MCS, an indicator of a MCS table, an indication on at least one QCLed RS, a time hopping pattern, a frequency hopping pattern, a hybrid automatic repeat request (HARQ) process identity (ID), a new data indicator, an indication that more sensing operations are required, at least one redundancy version for repeatable sensing resources, at least one patterns for repeatable sensing resources, at least one zone ID, at least one range requirement, a request for channel state information (CSI) report, or a cast type. In this way, configuration of time-frequency resource and associated parameters for the sensing operation may be indicated.

In some embodiments, the cast type may comprise at least one of the following: unicast, multi-cast, or broadcast. In this way, different cast types may be indicated by the second-stage DCI.

In some embodiments, the at least one configuration may indicate a sensing occasion comprising at least one sensing waveform, at least one time-frequency resource area, at least one carrier frequency, at least one bandwidth part (BWP), at least one time-frequency hopping pattern, and at least one subcarrier spacing. In this way, the DCI signaling for sensing operation may be simplified.

In some embodiments, multiple time-frequency patterns in the sensing occasion may be different in time-frequency resources and hopping patterns. In this way, time-frequency resources and hopping patterns may be configured flexibly.

In some embodiments, the time-frequency resources and the hopping patterns may be indexed. In this way, the overhead may be reduced.

In some embodiments, the at least one configuration may indicate at least one of the following: a time point when a sensing occasion starts, at least one time-frequency resource to be used, which is indexed using at least one resource index, at least one hopping pattern to be used, which is indexed using at least one hopping pattern index, at least one carrier frequency band, or at least one component carrier. In this way, the DCI signaling for sensing operation may be simplified.

In some embodiments, the set of configurations may be received by a radio resource control (RRC) message or a medium access control (MAC) control element (MAC CE). In this way, the set of configuration may be received in several manners.

In a sixth aspect, there is provided a method. The method comprising: receiving configuration information indicating a set of configurations for sensing operations, receiving a dedicated downlink control information (DCI) scheduling a sensing operation and indicating, among the set of configurations, at least one configuration for the sensing operation, and performing the sensing operation based on the dedicated DCI. As such, the scheduling of a sensing operation is simplified. Therefore, the overhead for the sensing operation is reduced.

In some embodiments, the at least one configuration may comprise at least one of the following information: at least one carrier frequency band, a duplex mode, at least one component carrier associated with at least one channel bandwidth, at least one subcarrier spacing to be used, an antenna configuration, a frequency resource assignment, a time resource assignment, at least one reference frequency domain location, at least one reference time location, at least one sensing type, a transmission or reception direction in a sensing operation, a set of reserved time or frequency resources, a resource reservation period, a sensing signal waveform, a sensing sequence configuration, a number of at least one DMRS port, an antenna port configuration, a MCS, an indicator of a MCS table, an indication on at least one QCLed RS, a time hopping pattern, a frequency hopping pattern, a hybrid automatic repeat request (HARQ) process identity (ID), a new data indicator, an indication that more sensing operations are required, at least one redundancy version for repeatable sensing resources, at least one patterns for repeatable sensing resources, at least one zone ID, at least one range requirement, a request for channel state information (CSI) report, or a cast type. In this way, configuration of time-frequency resource and associated parameters for the sensing operation may be indicated.

In some embodiments, the cast type comprises at least one of the following: unicast, multi-cast, or broadcast. In this way, different cast types may be indicated by the second-stage DCI.

In some embodiments, the at least one configuration may indicate a sensing occasion comprising at least one sensing waveform, at least one time-frequency resource area, at least one carrier frequency, at least one bandwidth part (BWP), at least one time-frequency hopping pattern, and at least one subcarrier spacing. In this way, the DCI signaling for sensing operation may be simplified.

In some embodiments, multiple time-frequency patterns in the sensing occasion may be different in time-frequency resources and hopping patterns. In this way, time-frequency resources and hopping patterns may be configured flexibly.

In some embodiments, the time-frequency resources and the hopping patterns may be indexed. In this way, the overhead may be reduced.

In some embodiments, the at least one configuration may indicate at least one of the following: a time point when a sensing occasion starts, at least one time-frequency resource to be used, which is indexed using at least one resource index, at least one hopping pattern to be used, which is indexed using at least one hopping pattern index, at least one carrier frequency band, or at least one component carrier. In this way, the DCI signaling for sensing operation may be simplified.

In some embodiments, the set of configurations may be received by a radio resource control (RRC) message or a medium access control (MAC) control element (MAC CE). In this way, the set of configuration may be received in several manners.

In some embodiments, performing the sensing operation may comprise: performing mono-static sensing in an indicated transmission or reception direction, performing bi-static sensing between a UE and a BS or between a UE and a UE, performing bi-static sensing in an indicated transmission or reception direction among a UE, a sensing target and a BS, or among a UE, a sensing target and a UE, performing multi-static sensing in an indicated transmission or reception direction among a UE, a sensing target and a BS, or among a UE, a sensing target and a UE, wherein a sensing source ID or a sensing reception ID may be included in the dedicated DCI. In this way, the sensing operation may be scheduled based on the dedicated DCI.

In a seventh aspect, there is provided a first device. The first device comprises a transceiver and a processor communicatively coupled with the transceiver. The processor is configured to transmit a first-stage downlink control information (DCI) for indicating at least one of a sensing operation or a communication operation to be scheduled; and transmit a second-stage DCI for scheduling the at least one of the sensing operation or the communication operation.

In an eighth aspect, there is provided a second device. The second device comprises a transceiver and a processor communicatively coupled with the transceiver. The processor is configured to receive a first-stage downlink control information (DCI) indicating that at least one of a sensing operation or a communication operation is to be scheduled; and receive a second-stage DCI for scheduling the at least one of the sensing operation or the communication operation.

In a ninth aspect, there is provided a first device. The first device comprises a transceiver and a processor communicatively coupled with the transceiver. The processor is configured to transmit a first-stage downlink control information (DCI) for indicating a sensing operation and a communication operation to be scheduled; and transmit a second-stage DCI for scheduling the sensing operation and the communication operation.

In a tenth aspect, there is provided a second device. The second device comprises a transceiver and a processor communicatively coupled with the transceiver. The processor is configured to receive a first-stage downlink control information (DCI) for indicating a sensing operation and a communication operation to be scheduled, and receive a second-stage DCI for scheduling the sensing operation and the communication operation.

In an eleventh aspect, there is provided a first device. The first device comprises a transceiver and a processor communicatively coupled with the transceiver. The processor is configured to transmit configuration information indicating a set of configurations for sensing operations; and transmit a dedicated downlink control information (DCI) scheduling a sensing operation and indicating, among the set of configurations, at least one configuration for the sensing operation.

In a twelfth aspect, there is provided a second device. The second device comprises a transceiver and a processor communicatively coupled with the transceiver. The processor is configured to receive configuration information indicating a set of configurations for sensing operations, receive a dedicated downlink control information (DCI) scheduling a sensing operation and indicating, among the set of configurations, at least one configuration for the sensing operation, and perform the sensing operation based on the dedicated DCI.

In a thirteenth aspect, there is provided a non-transitory computer readable medium comprising a computer program stored thereon, the computer program, when executed on at least one processor, causing the at least one processor to perform the method of any one of the first aspect or sixth aspect.

In a fourteenth aspect, there is provided a chip comprising at least one processing circuit configured to perform the method of any one of the first aspect or sixth aspect.

In a fifteenth aspect, there is provided a computer program product tangibly stored on a computer-readable medium and comprising computer-executable instructions which, when executed, cause an apparatus to perform the method of any one of the first aspect or sixth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example communication system in which example embodiments of the present disclosure may be implemented;

FIG. 1B illustrates an example communication system in which example embodiments of the present disclosure may be implemented;

FIG. 1C illustrates an example of an electronic device (ED) and base stations related to some embodiments of the present disclosure;

FIG. 1D illustrates an example of units or modules in a device related to some embodiments of the present disclosure;

FIG. 1E illustrates an example of a sensing management function (SMF) related to some embodiments of the present disclosure;

FIG. 1F illustrates an example of sensing and communication operations related to some embodiments of the present disclosure;

FIG. 2A illustrates an example signaling chart illustrating an example process according to some embodiments of the present disclosure;

FIG. 2B illustrates another example signaling chart illustrating an example process according to some embodiments of the present disclosure;

FIG. 2C illustrates yet another example signaling chart illustrating an example process according to some embodiments of the present disclosure;

FIG. 3 illustrates an example of two-stage DCIs for a sensing operation according to some embodiments of the present disclosure;

FIG. 4 illustrates an example of two-stage DCIs for a communication operation according to some embodiments of the present disclosure;

FIG. 5 illustrates an example of two-stage DCIs for sensing and communication operations according to some embodiments of the present disclosure;

FIG. 6 illustrates an example of a dedicated DCI signaling for a sensing operation according to some embodiments of the present disclosure;

FIG. 7 illustrates a flowchart of a method implemented at a first device according to some embodiments of the present disclosure;

FIG. 8 illustrates a flowchart of a method implemented at a second device according to some embodiments of the present disclosure;

FIG. 9 illustrates a flowchart of a method implemented at a first device according to some embodiments of the present disclosure;

FIG. 10 illustrates a flowchart of a method implemented at a second device according to some embodiments of the present disclosure;

FIG. 11 illustrates a flowchart of a method implemented at a first device according to some embodiments of the present disclosure;

FIG. 12 illustrates a flowchart of a method implemented at a second device according to some embodiments of the present disclosure;

FIG. 13 is a block diagram of a device that may be used for implementing some embodiments of the present disclosure;

FIG. 14 is a schematic diagram of a structure of an apparatus in accordance with some embodiments of the present disclosure;

FIG. 15 is a schematic diagram of a structure of an apparatus in accordance with some embodiments of the present disclosure;

FIG. 16 is a schematic diagram of a structure of an apparatus in accordance with some embodiments of the present disclosure;

FIG. 17 is a schematic diagram of a structure of an apparatus in accordance with some embodiments of the present disclosure;

FIG. 18 is a schematic diagram of a structure of an apparatus in accordance with some embodiments of the present disclosure; and

FIG. 19 is a schematic diagram of a structure of an apparatus in accordance with some embodiments of the present disclosure.

Throughout the drawings, the same or similar reference numerals represent the same or similar elements.

### DETAILED DESCRIPTION

Principles of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment”, “an embodiment”, “an example embodiment”, and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

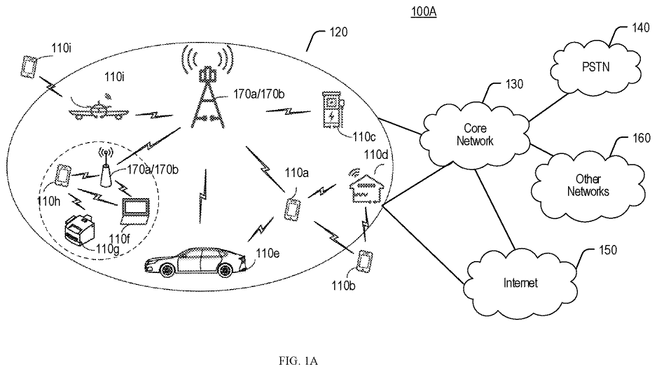

FIG. 1A illustrates an example communication system 100A in which example embodiments of the present disclosure may be implemented. Referring to FIG. 1A, as an illustrative example without limitation, a simplified schematic illustration of a communication system is provided. The communication system 100A comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100A. Also the communication system 100A comprises a public switched telephone network (PSTN) 140, the internet 150, and other networks 160.

FIG. 1B illustrates an example communication system in which example embodiments of the present disclosure may be implemented. In general, the communication system 100B enables multiple wireless or wired elements to communicate data and other content. The purpose of the communication system 100B may be to provide content, such as voice, data, video, signaling and/or text, via broadcast, multicast and unicast, etc. The communication system 100B may operate by sharing resources, such as carrier spectrum bandwidth, between its constituent elements. The communication system 100B may include a terrestrial communication system and/or a non-terrestrial communication system. The communication system 100B may provide a wide range of communication services and applications (such as earth monitoring, remote sensing, passive sensing and positioning, navigation and tracking, autonomous delivery and mobility, etc.). The communication system 100B may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

A terrestrial communication system may also be referred to as a land-based or ground-based communication system, although a terrestrial communication system can also, or instead, be implemented on or in water. The non-terrestrial communication system may bridge the coverage gaps for underserved areas by extending the coverage of cellular networks through non-terrestrial nodes, which will be key to ensuring global seamless coverage and providing mobile broadband services to unserved/underserved regions, in this case, it is hardly possible to implement terrestrial access-points/base-stations infrastructure in the areas like oceans, mountains, forests, or other remote areas.

The terrestrial communication system may be a wireless communications using 5G technology and/or later generation wireless technology (e.g., 6G or later). In some examples, the terrestrial communication system may also accommodate some legacy wireless technology (e.g., 3G or 4G wireless technology). The non-terrestrial communication system may be a communications using the satellite constellations like conventional Geo-Stationary Orbit (GEO) satellites which utilizing broadcast public/popular contents to a local server, Low earth orbit (LEO) satellites establishing a better balance between large coverage area and propagation path-loss/delay, stabilize satellites in very low earth orbits (VLEO) enabling technologies substantially reducing the costs for launching satellites to lower orbits, high altitude platforms (HAPs) providing a low path-loss air interface for the users with limited power budget, or Unmanned Aerial Vehicles (UAVs) (or unmanned aerial system (UAS)) achieving a dense deployment since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs coupled to integrate satellite communications to cellular networks emerging 3D vertical networks consist of many moving (other than geostationary satellites) and high altitude access points such as UAVs, HAPs and VLEOs.

The terrestrial communication system and the non-terrestrial communication system could be considered sub-systems of the communication system. In the example shown in FIG. 1B, the communication system 100B includes electronic devices (ED) 110a, 110b, 110c, 110d (generically referred to as ED 110), radio access networks (RANs) 120a-120b, a non-terrestrial communication network 120c, a core network 130, a public switched telephone network (PSTN) 140, the Internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 172, which may be generically referred to as a non-terrestrial transmit and receive point (NT-TRP) 172, or a sensing agent 172.

Any ED 110 may be alternatively or additionally configured to interface, access, or communicate with any T-TRP 170a-170b and NT-TRP 172, the Internet 150, the core network 130, the PSTN 140, the other networks 160, or any combination of the preceding. In some examples, ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100B may implement one or more channel access methods, such as code division multiple access (CDMA), space division multiple access (SDMA), time division multiple access (TDMA), frequency division multiple access (FDMA), orthogonal FDMA (OFDMA), Direct Fourier Transform spread OFDMA (DFT-OFDMA) or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 172 for multicast transmission.

The RANs 120a and 120b are in communication with the core network 130 to provide the EDs 110a, 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a, 110b, and 110c or both, and (ii) other networks (such as the PSTN 140, the Internet 150, the sensing agent 172, and the other networks 160). In addition, some or all of the EDs 110a, 110b, and 110c may include functionality for communicating with different wireless networks over different wireless links using different wireless technologies and/or protocols. Instead of wireless communication (or in addition thereto), the EDs 110a, 110b, and 110c may communicate via wired communication channels to a service provider or switch (not shown), and to the Internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a, 110b, and 110c may be multimode devices capable of operation according to multiple radio access technologies, and incorporate multiple transceivers necessary to support such.

Any or all of the EDs 110 and BS 170 may be sensing nodes in the system 100B. Sensing nodes are network entities that perform sensing by transmitting and receiving sensing signals. Some sensing nodes are communication equipment that perform both communications and sensing. However, it is possible that some sensing nodes do not perform communications, and are instead dedicated to sensing. The sensing agent is an example of a sensing node that is dedicated to sensing. Unlike the EDs 110 and BS 170, the sensing agent does not transmit or receive communication signals. However, the sensing agent may communicate configuration information, sensing information, signaling information, or other information within the communication system 100B. The sensing agent may be in communication with the core network 130 to communicate information with the rest of the communication system 100B. By way of example, the sensing agent may determine the location of the ED 110a, and transmit this information to the base station 170a via the core network 130. Although the sensing agent is not shown in FIG. 1B, any number of sensing agents may be implemented in the communication system 100B. In some embodiments, one or more sensing agents may be implemented at one or more of the RANs 120.

FIG. 1C illustrates an example of an electronic device (ED) and a base station related to some embodiments of the present disclosure. As shown in FIG. 1C, another example of an ED 110 and a base station 170a, 170b and/or 170c is provided. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, wearable devices such as a watch, head mounted equipment, a pair of glasses, an industrial device, or apparatus (e.g. communication module, modem, or chip) in the foregoing devices, among other possibilities. Future generation EDs 110 may be referred to using other terms. Each base station 170a and 170b is a T-TRP and will hereafter be referred to as T-TRP 170. Also shown in FIG. 1C, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one or more of: connection availability and connection necessity.

The ED 110 includes a transmitter 111 and a receiver 113 coupled to one or more antennas 104. Only one antenna 104 is illustrated. One, some, or all of the antennas 104 may alternatively be panels. The transmitter 111 and the receiver 113 may be integrated, e.g. as a transceiver. The transceiver may be integrated into a processor (e.g. processor 117). The transceiver is configured to modulate data or other content for transmission by at least one antenna 104 or network interface controller (NIC). The transceiver is also configured to demodulate data or other content received by the at least one antenna 104. Each transceiver includes any suitable structure for generating signals for wireless or wired transmission and/or processing signals received wirelessly or by wire. Each antenna 104 includes any suitable structure for transmitting and/or receiving wireless or wired signals.

The ED 110 includes at least one memory 115. The memory 115 stores instructions and data used, generated, or collected by the ED 110. For example, the memory 115 could store software instructions or modules configured to implement some or all of the functionality and/or embodiments described herein and that are executed by one or more processing unit(s) (e.g., a processor 117). Each memory 115 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to or receiving information from a user, such as through operation as a speaker, a microphone, a keypad, a keyboard, a display, or a touch screen, including network interface communications.

The ED 110 includes the processor 117 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 113, possibly using receive beamforming, and the processor 117 may extract signaling from the downlink transmission (e.g. by detecting and/or decoding the signaling). An example of signaling may be a reference signal transmitted by the NT-TRP 172 and/or by the T-TRP 170. In some embodiments, the processor 117 implements the transmit beamforming and/or the receive beamforming based on the indication of beam direction, e.g. beam angle information (BAI), received from the T-TRP 170. In some embodiments, the processor 117 may perform operations relating to network access (e.g. initial access) and/or downlink synchronization, such as operations relating to detecting a synchronization sequence, decoding and obtaining the system information, etc. In some embodiments, the processor 117 may perform channel estimation, e.g. using a reference signal received from the NT-TRP 172 and/or from the T-TRP 170.

Although not illustrated, the processor 117 may form part of the transmitter 111 and/or part of the receiver 113. Although not illustrated, the memory 115 may form part of the processor 117.

The processor 117, the processing components of the transmitter 111 and the processing components of the receiver 113 may each be implemented by the same or different one or more processors that are configured to execute instructions stored in a memory (e.g. in the memory 115). Alternatively, some or all of the processor 117, the processing components of the transmitter 111 and the processing components of the receiver 113 may each be implemented using dedicated circuitry, such as a programmed field-programmable gate array (FPGA), a graphical processing unit (GPU), a Central Processing Unit (CPU) or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 170 may be a macro BS, a pico BS, a relay node, a donor node, or the like, or combinations thereof. The T-TRP 170 may refer to the foregoing devices or refer to apparatus (e.g. a communication module, a modem, or a chip) in the foregoing devices.

In some embodiments, the parts of the T-TRP 170 may be distributed. For example, some of the modules of the T-TRP 170 may be located remote from the equipment that houses the antennas 256 for the T-TRP 170, and may be coupled to the equipment that houses the antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses the antennas 256 of the T-TRP 170. The modules may also be coupled to other T-TRPs. In some embodiments, the T-TRP 170 may actually be a plurality of T-TRPs that are operating together to serve the ED 110, e.g. through the use of coordinated multipoint transmissions.

The T-TRP 170 includes at least one transmitter 181 and at least one receiver 183 coupled to one or more antennas 256. Only one antenna 256 is illustrated. One, some, or all of the antennas 256 may alternatively be panels. The transmitter 181 and the receiver 183 may be integrated as a transceiver. The T-TRP 170 further includes a processor 182 for performing operations including those related to: preparing a transmission for downlink transmission to the ED 110, processing an uplink transmission received from the ED 110, preparing a transmission for backhaul transmission to the NT-TRP 172, and processing a transmission received over backhaul from the NT-TRP 172. Processing operations related to preparing a transmission for downlink or backhaul transmission may include operations such as encoding, modulating, precoding (e.g. multiple input multiple output (MIMO) precoding), transmit beamforming, and generating symbols for transmission. Processing operations related to processing received transmissions in the uplink or over backhaul may include operations such as receive beamforming, demodulating received symbols and decoding received symbols. The processor 182 may also perform operations relating to network access (e.g. initial access) and/or downlink synchronization, such as generating the content of synchronization signal blocks (SSBs), generating the system information, etc. In some embodiments, the processor 182 also generates an indication of beam direction, e.g. BAI, which may be scheduled for transmission by a scheduler 184. The processor 182 performs other network-side processing operations described herein, such as determining the location of the ED 110, determining where to deploy the NT-TRP 172, etc. In some embodiments, the processor 182 may generate signaling, e.g. to configure one or more parameters of the ED 110 and/or one or more parameters of the NT-TRP 172. Any signaling generated by the processor 182 is sent by the transmitter 181. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

The scheduler 184 may be coupled to the processor 182. The scheduler 184 may be included within or operated separately from the T-TRP 170. The scheduler 184 may schedule uplink, downlink, and/or backhaul transmissions, including issuing scheduling grants and/or configuring scheduling-free (“configured grant”) resources. The T-TRP 170 further includes a memory 185 for storing information and data. The memory 185 stores instructions and data used, generated, or collected by the T-TRP 170. For example, the memory 185 could store software instructions or modules configured to implement some or all of the functionality and/or embodiments described herein and that are executed by the processor 182.

Although not illustrated, the processor 182 may form part of the transmitter 181 and/or part of the receiver 183. Also, although not illustrated, the processor 182 may implement the scheduler 184. Although not illustrated, the memory 185 may form part of the processor 182.

The processor 182, the scheduler 184, the processing components of the transmitter 181 and the processing components of the receiver 183 may each be implemented by the same or different one or more processors that are configured to execute instructions stored in a memory, e.g. in the memory 185. Alternatively, some or all of the processor 182, the scheduler 184, the processing components of the transmitter 181 and the processing components of the receiver 183 may be implemented using dedicated circuitry, such as a FPGA, a GPU, a CPU, or an ASIC.

Although the NT-TRP 172 is illustrated as a drone only as an example, the NT-TRP 172 may be implemented in any suitable non-terrestrial form, such as high altitude platforms, satellite, high altitude platform as international mobile telecommunication base stations and unmanned aerial vehicles, which forms will be discussed hereinafter. Also, the NT-TRP 172 may be known by other names in some implementations, such as a non-terrestrial node, a non-terrestrial network device, or a non-terrestrial base station. The NT-TRP 172 includes a transmitter 186 and a receiver 187 coupled to one or more antennas 108. Only one antenna 108 is illustrated. One, some, or all of the antennas may alternatively be panels. The transmitter 186 and the receiver 187 may be integrated as a transceiver. The NT-TRP 172 further includes a processor 188 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating received symbols and decoding received symbols. In some embodiments, the processor 188 implements the transmit beamforming and/or receive beamforming based on beam direction information (e.g. BAI) received from the T-TRP 170. In some embodiments, the processor 188 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 189 for storing information and data. Although not illustrated, the processor 188 may form part of the transmitter 186 and/or part of the receiver 187. Although not illustrated, the memory 189 may form part of the processor 188.

The processor 188, the processing components of the transmitter 186 and the processing components of the receiver 187 may each be implemented by the same or different one or more processors that are configured to execute instructions stored in a memory, e.g. in the memory 189. Alternatively, some or all of the processor 188, the processing components of the transmitter 186 and the processing components of the receiver 187 may be implemented using dedicated circuitry, such as a programmed FPGA, a GPU, a CPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

FIG. 1D illustrates an example of units or modules in a device related to some embodiments of the present disclosure. One or more steps of the embodiment methods provided herein may be performed by corresponding units or modules, according to FIG. 1D. FIG. 1D illustrates units or modules in a device, such as in the ED 110, in the T-TRP 170, or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, a CPU, or an ASIC. It will be appreciated that where the modules are implemented using software for execution by a processor for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170, and the NT-TRP 172 are known to those of skill in the art. As such, these details are omitted here.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 182. FIG. 1E illustrates an example of a sensing management function (SMF) related to some embodiments of the present disclosure.

As shown in FIG. 1E, the SMF 176, when implemented as a physically independent entity, includes at least one processor 194, at least one transmitter 192, at least one receiver 196, one or more antennas 195, and at least one memory 199. A transceiver, not shown, may be used instead of the transmitter 192 and receiver 196. A scheduler 198 may be coupled to the processor 194. The scheduler 198 may be included within or operated separately from the SMF 176. The processor 194 implements various processing operations of the SMF 176, such as signal coding, data processing, power control, input/output processing, or any other functionality. The processor 194 can also be configured to implement some or all of the functionality and/or embodiments described in more detail above. Each processor 194 includes any suitable processing or computing device configured to perform one or more operations. Each processor 194 could, for example, include a microprocessor, microcontroller, digital signal processor, field programmable gate array, or application specific integrated circuit.

A reference signal-based pose determination technique belongs to an “active” pose estimation paradigm. In an active pose estimation paradigm, the enquirer of pose information (i.e., the UE) takes part in process of determining the pose of the enquirer. The enquirer may transmit or receive (or both) a signal specific to pose determination process. Positioning techniques based on a global navigation satellite system (GNSS) such as Global Positioning System (GPS) are other examples of the active pose estimation paradigm.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal, and a second set of channels may be used to transmit a communications signal. In some embodiments, each channel in the first set of channels and each channel in the second set of channels is a logical channel, a transport channel, or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) is used to carry control information for both sensing and communication. Alternatively, separate physical layer control channels may be used to carry separate control information for communication and sensing. For example, PUCCH-S and PUCCH-C could be used for uplink control for sensing and communication respectively, and PDCCH-S and PDCCH-C for downlink control for sensing and communication respectively.

Different combinations of shared and dedicated channels for sensing and communication, at each of the physical, transport, and logical layers, are possible.

The term RADAR originates from the phrase Radio Detection and Ranging; however, expressions with different forms of capitalization (i.e., Radar and radar) are equally valid and now more common. Radar is typically used for detecting a presence and a location of an object. A radar system radiates radio frequency energy and receives echoes of the energy reflected from one or more targets. The system determines the pose of a given target based on the echoes returned from the given target. The radiated energy can be in the form of an energy pulse or a continuous wave, which can be expressed or defined by a particular waveform. Examples of waveforms used in radar include frequency modulated continuous wave (FMCW) and ultra-wideband (UWB) waveforms.

Radar systems can be monostatic, bi-static, or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identify ability because terrestrial targets have similar physical attributes. Integrating sensing into a communication system is likely to suffer from these same challenges, and more.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g. data) over a wireless communications link. The wireless communications link may support a link between a radio access network and user equipment (e.g. a “Uu” link), and/or the wireless communications link may support a link between device and device, such as between two user equipments (e.g. a “sidelink”), and/or the wireless communications link may support a link between a non-terrestrial (NT)-communication network and user equipment (UE). The followings are some examples for the above components:

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform, and low Peak to Average Power Ratio Waveform (low PAPR WF). A frame structure component may specify a configuration of a frame or group of frames. The frame structure component may indicate one or more of a time, frequency, pilot signature, code, or other parameter of the frame or group of frames. More details of frame structure will be discussed below.

A multiple access scheme component may specify multiple access technique options, including technologies defining how communicating devices share a common physical channel, such as: Time Division Multiple Access (TDMA), Frequency Division Multiple Access (FDMA), Code Division Multiple Access (CDMA), Single Carrier Frequency Division Multiple Access (SC-FDMA), Low Density Signature Multicarrier Code Division Multiple Access (LDS-MC-CDMA), Non-Orthogonal Multiple Access (NOMA), Pattern Division Multiple Access (PDMA), Lattice Partition Multiple Access (LPMA), Resource Spread Multiple Access (RSMA), and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources, and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission, and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes, and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all concept”. For example, the components within the air interface cannot be changed or adapted once the air interface is defined. In some implementations, only limited parameters or modes of an air interface, such as a cyclic prefix (CP) length or a multiple input multiple output (MIMO) mode, can be configured. In some embodiments, an air interface design may provide a unified or flexible framework to support below 6 GHz and beyond 6 GHz frequency (e.g., mmWave) bands for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain, and a frequency domain self-contained design may support more flexible radio access network (RAN) slicing through channel resource sharing between different services in both frequency and time.

A frame structure is a feature of the wireless communication physical layer that defines a time domain signal transmission structure, e.g. to allow for timing reference and timing alignment of basic time domain transmission units. Wireless communication between communicating devices may occur on time-frequency resources governed by a frame structure. The frame structure may sometimes instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g. uplink vs. downlink) occur in different frequency bands. TDD communication is when transmissions in different directions (e.g. uplink vs. downlink) occur over different time durations. FD communication is when transmission and reception occurs on the same time-frequency resource, i.e. a device can both transmit and receive on the same frequency resource concurrently in time.

One example of a frame structure is a frame structure in long-term evolution (LTE) having the following specifications: each frame is 10 ms in duration; each frame has 10 subframes, which are each 1 ms in duration; each subframe includes two slots, each of which is 0.5 ms in duration; each slot is for transmission of 7 OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD has to be the integer time of OFDM symbol duration.

Another example of a frame structure is a frame structure in new radio (NR) having the following specifications: multiple subcarrier spacing is supported, each subcarrier spacing corresponding to a respective numerology; the frame structure depends on the numerology, but in any case the frame length is set at 10 ms, and consists of ten subframes of 1 ms each; a slot is defined as 14 OFDM symbols, and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing a slot length is 1 ms, and for 30 kHz subcarrier spacing a slot length is 0.5 ms. The NR frame structure may have more flexibility than the LTE frame structure.

Another example of a frame structure is an example flexible frame structure, e.g. for use in a 6G network or later. In a flexible frame structure, a symbol block may be defined as the minimum duration of time that may be scheduled in the flexible frame structure. A symbol block may be a unit of transmission having an optional redundancy portion (e.g. CP portion) and an information (e.g. data) portion. An OFDM symbol is an example of a symbol block. A symbol block may alternatively be called a symbol. Embodiments of flexible frame structures include different parameters that may be configurable, e.g. frame length, subframe length, symbol block length, etc. A non-exhaustive list of possible configurable parameters in some embodiments of a flexible frame structure include:
(1) Frame: The frame length need not be limited to 10 ms, and the frame length may be configurable and change over time. In some embodiments, each frame includes one or multiple downlink synchronization channels and/or one or multiple downlink broadcast channels, and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set as 5 ms for autonomous vehicle applications. As another example, smart meters on houses may not require fast initial access, in which case the frame length may be set as 20 ms for smart meter applications.
(2) Subframe duration: A subframe might or might not be defined in the flexible frame structure, depending upon the implementation. For example, a frame may be defined to include slots, but no subframes. In frames in which a subframe is defined, e.g. for time domain alignment, then the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.
(3) Slot configuration: A slot might or might not be defined in the flexible frame structure, depending upon the implementation. In frames in which a slot is defined, then the definition of a slot (e.g. in time duration and/or in number of symbol blocks) may be configurable. In one embodiment, the slot configuration is common to all UEs or a group of UEs. For this case, the slot configuration information may be transmitted to UEs in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration can be transmitted independently from the frame configuration signaling and/or subframe configuration signaling. In general, the slot configuration may be system common, base station common, UE group common, or UE specific.
(4) Subcarrier spacing (SCS): SCS is one parameter of scalable numerology which may allow the SCS to possibly range from 15 KHz to 480 KHz. The SCS may vary with the frequency of the spectrum and/or maximum UE speed to minimize the impact of the Doppler shift and phase noise. In some examples, there may be separate transmission and reception frames, and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g. if more flexible symbol durations are implemented using inverse discrete Fourier transform (IDFT) instead of fast Fourier transform (FFT). Additional examples of frame structures can be used with different SCSs.
(5) Flexible transmission duration of basic transmission unit: The basic transmission unit may be a symbol block (alternatively called a symbol), which in general includes a redundancy portion (referred to as the CP) and an information (e.g. data) portion, although in some embodiments the CP may be omitted from the symbol block. The CP length may be flexible and configurable. The CP length may be fixed within a frame or flexible within a frame, and the CP length may possibly change from one frame to another, or from one group of frames to another group of frames, or from one subframe to another subframe, or from one slot to another slot, or dynamically from one scheduling to another scheduling. The information (e.g. data) portion may be flexible and configurable. Another possible parameter relating to a symbol block that may be defined is ratio of CP duration to information (e.g. data) duration. In some embodiments, the symbol block length may be adjusted according to: channel condition (e.g. multi-path delay, Doppler); and/or latency requirement; and/or available time duration. As another example, a symbol block length may be adjusted to fit an available time duration in the frame.
(6) Flexible switch gap: A frame may include both a downlink portion for downlink transmissions from a base station, and an uplink portion for uplink transmissions from UEs. A gap may be present between each uplink and downlink portion, which is referred to as a switching gap. The switching gap length (duration) may be configurable. A switching gap duration may be fixed within a frame or flexible within a frame, and a switching gap duration may possibly change from one frame to another, or from one group of frames to another group of frames, or from one subframe to another subframe, or from one slot to another slot, or dynamically from one scheduling to another scheduling.

A device, such as a base station, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g. the center or lowest or highest frequency of the carrier. A carrier may be on licensed or unlicensed spectrum. Wireless communication with the device may also or instead occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and optionally one or multiple uplink resources, or a cell may include one or multiple uplink resources and optionally one or multiple downlink resources, or a cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may instead or additionally include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g. a carrier may have a bandwidth of 20 MHz and consist of one BWP, or a carrier may have a bandwidth of 80 MHz and consist of two adjacent contiguous BWPs, etc. In other embodiments, a BWP may have one or more carriers, e.g. a BWP may have a bandwidth of 40 MHz and consists of two adjacent contiguous carriers, where each carrier has a bandwidth of 20 MHz. In some embodiments, a BWP may comprise non-contiguous spectrum resources which consists of non-contiguous multiple carriers, where the first carrier of the non-contiguous multiple carriers may be in mmW band, the second carrier may be in a low band (such as 2 GHz band), the third carrier (if it exists) may be in THz band, and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits.

The carrier, the BWP, or the occupied bandwidth may be signaled by a network device (e.g. base station) dynamically, e.g. in physical layer control signaling such as DCI, or semi-statically, e.g. in radio resource control (RRC) signaling or in the medium access control (MAC) layer, or be predefined based on the application scenario; or be determined by the UE as a function of other parameters that are known by the UE, or may be fixed, e.g. by a standard.

In current networks, frame timing and synchronization is established based on synchronization signals, such as a primary synchronization signal (PSS) and a secondary synchronization signal (SSS). Notably, known frame timing and synchronization strategies involve adding a timestamp, e.g., (xxo:yyo:zz), to a frame boundary, where xxo, yyo, zz in the timestamp may represent a time format such as hour, minute, and second, respectively.

It is anticipated that diverse applications and use cases in future networks may involve usage of different periods of frames, slots and symbols to satisfy the different requirements, functionalities and Quality of Service (QoS) types. It follows that usage of different periods of frames to satisfy these applications may present challenges for frame timing alignment among diverse frame structures. Consider, for example, frame timing alignment for a TDD configuration in neighboring carrier frequency bands or among sub-bands (or bandwidth parts) of one channel/carrier bandwidth.

The present disclosure relates, generally, to mobile, wireless communication and, in particular embodiments, to a frame timing alignment/realignment, where the frame timing alignment/realignment may comprise a timing alignment/realignment in terms of a boundary of a symbol, a slot or a sub-frame within a frame; or a frame (thus the frame timing alignment/realignment here is more general, not limiting to the cases where a timing alignment/realignment is from a frame boundary only). Also, in this application, relative timing to a frame or frame boundary should be interpreted in a more general sense, i.e., the frame boundary means a timing point of a frame element with the frame such as (starting or ending of) a symbol, a slot or subframe within a frame, or a frame. In the following, the phrases “(frame) timing alignment or timing realignment” and “relative timing to a frame boundary” are used in more general sense described in above.

In overview, aspects of the present application relate to a network device, such as a base station 170, referenced hereinafter as a TRP 170, transmitting signaling that carries a timing realignment indication message. The timing realignment indication message includes information allowing a receiving UE 110 to determine a timing reference point. On the basis of the timing reference point, transmission of frames, by the UE 110, may be aligned. In some aspects of the present application, the frames that become aligned are in different sub-bands of one carrier frequency band. In other aspects of the present application, the frames that become aligned are found in neighboring carrier frequency bands.

On the TRP 170 side, aspects of the present application relate to use of one or more types of signaling to indicate the timing realignment (or/and timing correction) message. Two example types of signaling are provided here to show the schemes. The first example type of signaling may be referenced as cell-specific signaling, examples of which include group common signaling and broadcast signaling. The second example type of signaling may be referenced as UE-specific signaling. One of these two types of signaling or a combination of the two types of signaling may be used to transmit a timing realignment indication message. The timing realignment indication message may be shown to notify one or more UEs 110 of a configuration of a timing reference point. References, hereinafter, to the term “UE 110” may be understood to represent reference to a broad class of generic wireless communication devices within a cell (i.e., a network receiving node, such as a wireless device, a sensor, a gateway, a router, etc.), that is, being served by the TRP 170. A timing reference point is a timing reference instant and may be expressed in terms of a relative timing, in view of a timing point in a frame, such as (starting or ending boundary of) a symbol, a slot or a sub-frame within a frame; or a frame. For a simple description in the following, the term “a frame boundary” is used to represent a boundary of possibly a symbol, a slot or a sub-frame within a frame; or a frame. Thus, the timing reference point may be expressed in terms of a relative timing, in view of a current frame boundary, e.g., the start of the current frame. Alternatively, the timing reference point may be expressed in terms of an absolute timing based on certain standards timing reference such as a GNSS (e.g., GPS), Coordinated Universal Time (“UTC”), etc. In the absolute timing version of the timing reference point, a timing reference point may be explicitly stated.

The timing reference point may be shown to allow for timing adjustments to be implemented at the UEs 110. The timing adjustments may be implemented for improvement of accuracy for a clock at the UE 110. Alternatively, or additionally, the timing reference point may be shown to allow for adjustments to be implemented in future transmissions made from the UEs 110. The adjustments may be shown to cause realignment of transmitted frames at the timing reference point. Note that the realignment of transmitted frames at the timing reference point may comprise the timing realignment from (the starting boundary of) a symbol, a slot or a sub-frame within a frame; or a frame at the timing reference point for one or more UEs and one or more BSs (in a cell or a group of cells), which applies across the application below.

At UE 110 side, the UE 110 may monitor for the timing realignment indication message. Responsive to receiving the timing realignment indication message, the UE 110 may obtain the timing reference point and take steps to cause frame realignment at the timing reference point. Those steps may, for example, include commencing transmission of a subsequent frame at the timing reference point.

Furthermore, or alternatively, before monitoring for the timing realignment indication message, the UE 110 may cause the TRP 170 to transmit the timing realignment indication message by transmitting, to the TRP 170, a request for a timing realignment, that is, a timing realignment request message. Responsive to receiving the timing realignment request message, the TRP 170 may transmit, to the UE 110, a timing realignment indication message including information on a timing reference point, thereby allowing the UE 110 to implement a timing realignment (or/and a timing adjustment including clock timing error correction), wherein the timing realignment is in terms of (e.g., a starting boundary of) a symbol, a slot or a sub-frame within a frame; or a frame for UEs and base station(s) in a cell (or a group of cells).

According to aspects of the present application, a TRP 170 associated with a given cell may transmit a timing realignment indication message. The timing realignment indication message may include enough information to allow a receiver of the message to obtain a timing reference point. The timing reference point may be used, by one or more UEs 110 in the given cell, when performing a timing realignment (or/and a timing adjustment including clock timing error correction).

According to aspects of the present application, the timing reference point may be expressed, within the timing realignment indication message, relative to a frame boundary (where, as previously described and to be applicable below across the application, a frame boundary can be a boundary of a symbol, a slot or a sub-frame with a frame; or a frame). The timing realignment indication message may include a relative timing indication, Δt. It may be shown that the relative timing indication, Δt, expresses the timing reference point as occurring a particular duration, i.e., Δt, subsequent to a frame boundary for a given frame. Since the frame boundary is important to allowing the UE 110 to determine the timing reference point, it is important that the UE 110 be aware of the given frame that has the frame boundary of interest. Accordingly, the timing realignment indication message may also include a system frame number (SFN) for the given frame.

It is known, in 5G NR, that the SFN is a value in range from 0 to 1023, inclusive. Accordingly, 10 bits may be used to represent a SFN. When a SFN is carried by an SSB, six of the 10 bits for the SFN may be carried in a Master Information Block (MIB) and the remaining four bits of the 10 bits for the SFN may be carried in a Physical Broadcast Channel (PBCH) payload.

Optionally, the timing realignment indication message may include other parameters. The other parameters may, for example, include a minimum time offset. The minimum time offset may establish a duration of time preceding the timing reference point. The UE 110 may rely upon the minimum time offset as an indication that DL signaling, including the timing realignment indication message, will allow the UE 110 enough time to detect the timing realignment indication message to obtain information on the timing reference point.

User Equipment (UE) position information is often used in cellular communication networks to improve various performance metrics for the network. Such performance metrics may, for example, include capacity, agility, and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including its location in a global coordinate system, its velocity and direction of movement in the global coordinate system, orientation information, and the information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system can be separate from the communication system, it could be advantageous to gather the information using an integrated system, which reduces the hardware (and cost) in the system as well as the time, frequency, or spatial resources needed to perform both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Communication nodes can be either half-duplex or full-duplex. A half-duplex node cannot both transmit and receive using the same physical resources (time, frequency, etc.); conversely, a full-duplex node can transmit and receive using the same physical resources. Existing commercial wireless communications networks are all half-duplex. Even if full-duplex communications networks become practical in the future, it is expected that at least some of the nodes in the network will still be half.

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that can be used for a sensing signal include ultra-wide band (UWB) pulse, Frequency-Modulated Continuous Wave (FMCW) or “chirp”, orthogonal frequency-division multiplexing (OFDM), cyclic prefix (CP)-OFDM, and Discrete Fourier Transform spread (DFT-s)-OFDM.

In an embodiment, the sensing signal is a linear chirp signal with bandwidth B and time duration T. Such a linear chirp signal is generally known from its use in FMCW radar systems. A linear chirp signal is defined by an increase in frequency from an initial frequency, f_{chirp0}, at an initial time, t_{chirp0}, to a final frequency, f_{chirp1}, at a final time, t_{chirp1} where the relation between the frequency (f) and time (t) can be expressed as a linear relation of f−f_{chirp0}=α(t−t_{chirp0}), where

$$α = \frac{{f}_{chirp 1} - {f}_{chirp 0}}{{t}_{chirp 1} - {t}_{chirp 0}}$$

is defined as the chirp slope. The bandwidth of the linear chirp signal may be defined as B=f_{chirp1}−f_{chirp0} and the time duration of the linear chirp signal may be defined as T=t_{chirp1}−t_{chirp0}. Such linear chirp signal can be presented as e^{jπαt}^{²} in the baseband representation.

Precoding as used herein may refer to any coding operation(s) or modulation(s) that transform an input signal into an output signal. Precoding may be performed in different domains, and typically transform the input signal in a first domain to an output signal in a second domain. Precoding may include linear operations.

Multiple input multiple-output (MIMO) technology allows an antenna array of multiple antennas to perform signal transmissions and receptions to meet high transmission rate requirement. The above ED 110 and T-TRP 170, and/or NT-TRP use MIMO to communicate over the wireless resource blocks. MIMO utilizes multiple antennas at the transmitter and/or receiver to transmit wireless resource blocks over parallel wireless signals. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the above T-TRP 170, and/or NT-TRP 172 configured with a large number of antennas has gained wide attentions from the academia and the industry. In the large-scale MIMO system, the T-TRP 170, and/or NT-TRP 172 is generally configured with more than ten antenna units (such as 128 or 256), and serves for dozens of the ED 110 (such as 40) in the meanwhile. A large number of antenna units of the T-TRP 170, and NT-TRP 172 can greatly increase the degree of spatial freedom of wireless communication, greatly improve the transmission rate, spectrum efficiency and power efficiency, and eliminate the interference between cells to a large extent. The increase of the number of antennas makes each antenna unit be made in a smaller size with a lower cost. Using the degree of spatial freedom provided by the large-scale antenna units, the T-TRP 170, and NT-TRP 172 of each cell can communicate with many ED 110 in the cell on the same time-frequency resource at the same time, thus greatly increasing the spectrum efficiency. A large number of antenna units of the T-TRP 170, and/or NT-TRP 172 also enable each user to have better spatial directivity for uplink and downlink transmission, so that the transmitting power of the T-TRP 170, and/or NT-TRP 172 and a ED 110 is obviously reduced, and the power efficiency is greatly increased. When the antenna number of the T-TRP 170, and/or NT-TRP 172 is sufficiently large, random channels between each ED 110 and the T-TRP 170, and/or NT-TRP 172 can approach to be orthogonal, and the interference between the cell and the users and the effect of noises can be eliminated. The plurality of advantages described above enable the large-scale MIMO to have a magnificent application prospect.

A MIMO system may include a receiver connected to a receive (Rx) antenna, a transmitter connected to transmit (Tx) antenna, and a signal processor connected to the transmitter and the receiver. Each of the Rx antenna and the Tx antenna may include a plurality of antennas. For instance, the Rx antenna may have an ULA antenna array in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include:
Panel: unit of antenna group, or antenna array, or antenna sub-array which can control its Tx or Rx beam independently.
Beam: A beam is formed by performing amplitude and/or phase weighting on data transmitted or received by at least one antenna port, or may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. The beam information may be a beam identifier, or antenna port(s) identifier, or CSI-RS resource identifier, or SSB resource identifier, or SRS resource identifier, or other reference signal resource identifier

Artificial Intelligence technologies can be applied in communication, including artificial intelligence or machine learning (AI/ML) based communication in the physical layer and/or AI/ML based communication in the higher layer, e.g., medium access control (MAC) layer. For example, in the physical layer, the AI/ML based communication may aim to optimize component design and/or improve the algorithm performance. For the MAC layer, the AI/ML based communication may aim to utilize the AI/ML capability for learning, prediction, and/or making a decision to solve a complicated optimization problem with possible better strategy and/or optimal solution, e.g. to optimize the functionality in the MAC layer, e.g. intelligent TRP management, intelligent beam management, intelligent channel resource allocation, intelligent power control, intelligent spectrum utilization, intelligent modulation and coding scheme (MCS), intelligent hybrid automatic repeat request (HARQ) strategy, intelligent transmit/receive (Tx/Rx) mode adaption, etc. The following are some terminologies which are used in AI/ML field:
Data collection: Data is the very important component for AI/ML techniques. Data collection is a process of collecting data by the network nodes, management entity, or UE for the purpose of AI/ML model training, data analytics and inference.
AI/ML model training: AI/ML model training is a process to train an AI/ML Model by learning the input/output relationship in a data driven manner and obtain the trained AI/ML Model for inference.
AI/ML model inference: a process of using a trained AI/ML model to produce a set of outputs based on a set of inputs.
AI/ML model validation: as a sub-process of training, validation is used to evaluate the quality of an AI/ML model using a dataset different from the one used for model training. Validation can help selecting model parameters that generalize beyond the dataset used for model training. The model parameter after training can be adjusted further by the validation process.
AI/ML model testing: similar with validation, testing is also a sub-process of training, and it is used to evaluate the performance of a final AI/ML model using a dataset different from the one used for model training and validation. Differently from AI/ML model validation, testing does not assume subsequent tuning of the model.
Online training: online training means an AI/ML training process where the model being used for inference is typically continuously trained in (near) real-time with the arrival of new training samples.
Offline training: an AI/ML training process where the model is trained based on collected dataset, and where the trained model is later used or delivered for inference.
AI/ML model delivery/transfer: a generic term referring to delivery of an AI/ML model from one entity to another entity in any manner. Delivery of an AI/ML model over the air interface includes either parameters of a model structure known at the receiving end or a new model with parameters. Delivery may contain a full model or a partial model.
Life cycle management (LCM): when the AI/ML model is trained and/or inferred at one device, it is necessary to monitor and manage the whole AI/ML process to guarantee the performance gain obtained by AI/ML technologies. For example, due to the randomness of wireless channels and the mobility of UEs, the propagation environment of wireless signals changes frequently. Nevertheless, it is difficult for an AI/ML model to maintain optimal performance in all scenarios for all the time, and the performance may even deteriorate sharply in some scenarios. Therefore, the lifecycle management (LCM) of AI/ML models is essential for sustainable operation of AI/ML in NR air-interface. Life cycle management covers the whole procedure of AI/ML technologies which applied on one or more nodes. In specific, it includes at least one of the following sub-process: data collection, model training, model identification, model registration, model deployment, model configuration, model inference, model selection, model activation, deactivation, model switching, model fallback, model monitoring, model update, model transfer/delivery and UE capability report. Model monitoring can be based on inference accuracy, including metrics related to intermediate key performance indicator (KPI) s, and it can also be based on system performance, including metrics related to system performance KPIs, e.g., accuracy and relevance, overhead, complexity (computation and memory cost), latency (timeliness of monitoring result, from model failure to action) and power consumption. Moreover, data distribution may shift after deployment due to the environment changes, thus the model based on input or output data distribution should also be considered.
Supervised learning: the goal of supervised learning algorithms is to train a model that maps feature vectors (inputs) to labels (output), based on the training data which includes the example feature-label pairs. The supervised learning can analyze the training data and produce an inferred function, which can be used for mapping the inference data. Supervised learning can be further divided into two types: Classification and Regression. Classification is used when the output of the AI/ML model is categorical i.e. with two or more classes. Regression is used when the output of the AI/ML model is a real or continuous value.
Unsupervised learning: in contrast to supervised learning where the AI/ML models learn to map the input to the target output, the unsupervised methods learn concise representations of the input data without the labelled data, which can be used for data exploration or to analyze or generate new data. One typical unsupervised learning is clustering which explores the hidden structure of input data and provide the classification results for the data.
Reinforce learning: reinforce learning is used to solve sequential decision-making problems. Reinforce learning is a process of training the action of intelligent agent from input (state) and a feedback signal (reward) in an environment. In reinforce learning, an intelligent agent interacts with an environment by taking an action to maximize the cumulative reward. Whenever the intelligent agent takes one action, the current state in the environment may transfer to the new state, and the new state resulted by the action will bring to the associated reward. Then the intelligent agent can take the next action based on the received reward and new state in the environment. During the training phase, the agent interacts with the environment to collect experience. The environments often mimicked by the simulator since it is expensive to directly interact with the real system. In the inference phase, the agent can use the optimal decision-making rule learned from the training phase to achieve the maximal accumulated reward.
Federated learning: federated learning (FL) is a machine learning technique that is used to train an AI/ML model by a central node (e.g., server) and a plurality of decentralized edge nodes (e.g., UEs, next Generation NodeBs, “gNBs”).

According to the wireless FL technique, a server may provide, to an edge node, a set of model parameters (e.g., weights, biases, gradients) that describe a global AI/ML model. The edge node may initialize a local AI/ML model with the received global AI/ML model parameters. The edge node may then train the local AI/ML model using local data samples to, thereby, produce a trained local AI/ML model. The edge node may then provide, to the serve, a set of AI/ML model parameters that describe the local AI/ML model.

Upon receiving, from a plurality of edge nodes, a plurality of sets of AI/ML model parameters that describe respective local AI/ML models at the plurality of edge nodes, the server may aggregate the local AI/ML model parameters reported from the plurality of UEs and, based on such aggregation, update the global AI/ML model. A subsequent iteration progresses much like the first iteration. The server may transmit the aggregated global model to a plurality of edge nodes. The above procedure is performed multiple iterations until the global AI/ML model is considered to be finalized, e.g., the AI/ML model is converged or the training stopping conditions are satisfied.

Notably, the wireless FL technique does not involve exchange of local data samples. Indeed, the local data samples remain at respective edge nodes.

AI technologies (which encompass ML technologies) may be applied in communication, including AI-based communication in the physical layer and/or AI-based communication in the MAC layer. For the physical layer, the AI communication may aim to optimize component design and/or improve the algorithm performance. For example, AI may be applied in relation to the implementation of: channel coding, channel modelling, channel estimation, channel decoding, modulation, demodulation, MIMO, waveform, multiple access, physical layer element parameter optimization and update, beam forming, tracking, sensing, and/or positioning, etc. For the MAC layer, the AI communication may aim to utilize the AI capability for learning, prediction, and/or making a decision to solve a complicated optimization problem with possible better strategy and/or optimal solution, e.g. to optimize the functionality in the MAC layer. For example, AI may be applied to implement: intelligent TRP management, intelligent beam management, intelligent channel resource allocation, intelligent power control, intelligent spectrum utilization, intelligent MCS, intelligent HARQ strategy, and/or intelligent transmission/reception mode adaption, etc.

An AI architecture may involve multiple nodes, where the multiple nodes may possibly be organized in one of two modes, i.e., centralized and distributed, both of which may be deployed in an access network, a core network, or an edge computing system or third party network. A centralized training and computing architecture is restricted by possibly large communication overhead and strict user data privacy. A distributed training and computing architecture may comprise several frameworks, e.g., distributed machine learning and federated learning. In some embodiments, an AI architecture may comprise an intelligent controller which can perform as a single agent or a multi-agent, based on joint optimization or individual optimization. New protocols and signaling mechanisms are desired so that the corresponding interface link can be personalized with customized parameters to meet particular requirements while minimizing signaling overhead and maximizing the whole system spectrum efficiency by personalized AI technologies.

New protocols and signaling mechanisms are provided for operating within and switching between different modes of operation, including between AI and non-AI modes, and for measurement and feedback to accommodate the different possible measurements and information that may need to be fed back, depending upon the implementation.

An air interface that uses AI as part of the implementation, e.g. to optimize one or more components of the air interface, will be referred to herein as an “AI enabled air interface”. In some embodiments, there may be two types of AI operation in an AI enabled air interface: both the network and the UE implement learning; or learning is only applied by the network.

Future wireless network such as 6G network may support an important feature: integrated sensing and communication (ISAC). A communication operation is used to provide transmissions of data or control information between user equipment (UE) and network (e.g., base station), between UEs and/or between base stations. A sensing operation is used to provide a measurement via a sensing signal, and the measurement may include an estimation on distance, ranging, size and/or orientation of a UE or an object target. FIG. 1F illustrates an example of sensing and communication operations related to some embodiments of the present disclosure. As shown in FIG. 1F, sensing and communication operations are performed among a BS, U users (such as User 1, . . . , User U) and K passive sensing targets (such as Target 1, . . . , Target K), where any of K passive sensing targets may, for example, reflect sensing signals rather than transmit or receive sensing signals. There are communication signals and sensing signals transmitted between the BS, U users and K passive sensing targets. The communication signals and sensing signals may or may not be similar in terms of, for example, carrier frequency band, component carrier, signal bandwidth, or signal waveform, etc. Sensing signal transmission and measurement may include different sensing types, e.g., mono-static sensing, bi-static sensing and multi-static sensing where a sensing target can include one or more of device, base station, an object (i.e., a passively sensed target), channel measurement, beamforming information (including beam direction for transmission or reception).

However, as communication and sensing may take more or share resources and spectrum, and how to schedule sensing and communication operations and effectively use the resources between communication and sensing can be important issues that are required to be addressed. Communication and sensing operations can be scheduled in separate time-frequency resources or in shared spectrum with time domain separation. Usually, sensing operations may target for distance, ranging or orientation estimation such that sensing signal may often have (much) larger signal bandwidth (BW) than (data) communication where the throughput and spectrum efficiency are of more interest.

Sensing signal may burst in certain patterns over time and frequency resources and be transmitted periodically or aperiodic. Due to the nature of sensing operation, sensing signals may have larger bandwidth than communication signals, and it is possible that communication and sensing signals may be overlapped in frequency domain. In future wireless system, one network node (such as base station) or terminal device (such as user equipment, UE) may support both sensing and communication operations. In another word, one network node or terminal device may transmit and/or receive sensing signals, communication signals, or both signals with varying duplex modes such as time division duplex (TDD), frequency division duplex (FDD), full duplex (FD), etc.

In communication operation, transmissions or receptions of a UE are scheduled by a downlink control information (DCI). In sensing operation, sensing signal transmissions or receptions may be also scheduled by a DCI. To support sensing and/or communication operations, single network framework and signaling mechanism (e.g., using DCI, RRC, medium access control control element or a combination of thereof) may be used to schedule sensing operation, communication operation, or both sensing and communication operations. System and scheme on unified integrated sensing and communication framework and signaling are designed.

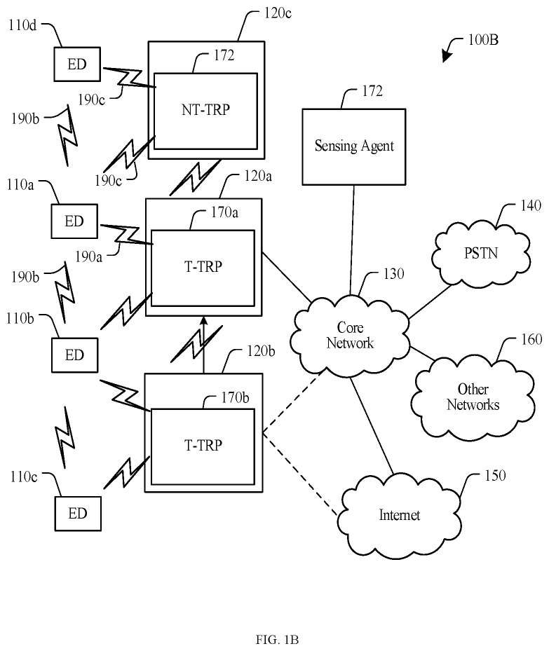

According to embodiments of the present disclosure, there is provided a solution for scheduling of a sensing operation and/or a communication operation. In an aspect, a first device transmits a first-stage DCI for indicating that at least one of a sensing operation or a communication operation to be scheduled. After that the first device transmits a second-stage DCI for scheduling the at least one of the sensing operation or the communication operation. In this way, the scheduling of a sensing operation and/or a communication operation is simplified. Therefore, the overhead for the sensing operation and the communication operation is reduced. Principles and implementations of embodiments of the present disclosure will be described in detail below with reference to FIGS. 2A-19.

FIGS. 2A-2C illustrate signaling charts illustrating different example processes according to some embodiments of the present disclosure. The process 200A may involve a first device 201 and a second device 202. The first device 201 in FIG. 2A may be an example of the network node 170 in FIG. 1A. The second device 202 in FIG. 2A may be an example of the communication electric device 110 in FIG. 1A. It would be appreciated that although the process flow 200A has been described in the communication system 100A of FIG. 1A, this process may be likewise applied to other communication scenarios.

In the process flow 200A, the first device 201 transmits 210 a first-stage DCI 212 to the second device 202. The first-stage DCI 212 indicates at least one of a sensing operation or a communication operation to be scheduled. On the other side of the communication, the second device 202 receives 214 the first-stage DCI 212 from the first device 201. In other words, the first-stage DCI may comprise information to indicate which operation(s) to be scheduled.

The first-stage DCI 212 is comprised in two-stage DCIs (also called two-level DCIs) in a unified framework for the sensing operation and the communication operation. The unified framework may comprise at least one shared scheduling or at least one shared DCI to indicate which one of sensing and communication operations, or both operations, and to include associated resource allocation(s) and operation parameters. The two-stage DCIs further comprises a second-stage DCI.

In some embodiments, the first-stage DCI may comprise the following information for the at least one of the sensing operation or the communication operation: at least one carrier frequency band, e.g., 6 GHZ, below 6 GHz and above 6 GHz bands; a duplex mode, e.g., TDD or FDD; at least one component carrier associated with at least one channel bandwidth; at least one subcarrier spacing to be used; numerology to be used; an antenna configuration or configuration index, for example, the antenna configuration or the configuration index may include beamforming configuration or index, and the details of the antenna configuration or the configuration index have been provided by RRC; a frequency resource assignment for the second-stage DCI; a time resource assignment for the second-stage DCI; an indication of a PDCCH in a CORESET for carrying the second-stage DCI; at least one reference frequency domain location; at least one reference time location; at least one sensing type; a transmission or reception direction in a sensing operation; a set of reserved time or frequency resources, for example, a reserved resource may be used by an activation/notification, deactivation, default usage (e.g., reserved or no usage); a resource reservation period, for example, a resource reservation period or indication may be used for a reserved purpose; a DMRS pattern for the communication operation; a sensing signal waveform for the sensing operation; a sensing sequence configuration; a DCI format of the second-stage DCI, optionally among multiple DCI formats; a number of at least one DMRS port; an antenna port configuration or an antenna port indication; a MCS, for example, 5 bits or more bits based on one or more MCS tables that may be indicated in the first-stage DCI or in other message separately; an indicator of a MCS table, for example, an additional MCS table indicator to be used among one or more MCS tables that are defined, pre-configured or configured by higher layer signaling such as RRC; an indication of one of the sensing operation or the communication operation for which rate matching is to be performed in case of resource usage conflict between the sensing operation and the communication operation; an indication on at least one QCLed RS, or at least one index of at least one RS indicating which operation the reference signal is used for; or any combination of two or more of the above-mentioned items.

In some embodiments, two or more bits in the first-stage DCI, which may correspond to a first field (or first fields) in the first-stage DCI, may be used to indicate a type of operation. The type of operation may include a sensing operation, a communication operation, or both a sensing operation and a communication operation. The two or more bits can also indicate any other type of information such as a special signaling or notification. For example, if two bits are used, amongst the four combinations of values of the two bits (e.g. “00”, “01”, “10”, and “11”): three options may indicate one of: a sensing operation, a communication operation, or both a sensing operation and a communication operation; and a fourth option can be reserved or can be used to indicate any other information including a special signaling or notification. In another example, if three bits are used, amongst the eight combinations: three options may indicate one of: a sensing operation, a communication operation, or both a sensing operation and a communication operation; and the remaining five options can be used for the special signaling or notification. The special signaling or notification may include one or more of the following: a system information update, varying types of warning (such as security, weather forecast, etc.), a skipping notification on some messages (such as paging, measurement, resource preemption, rate matching, etc.), a priority indication on resource usage for sensing and/or communication, a quasi-collocated reference signal indication, a transceiver type (e.g., a low-power transceiver, a high-power transceiver) indication/switching, a configured resource usage activation, or a configured resource usage de-activation, etc., or a combination thereof.

In another embodiment, combinations of values of one or more bits in the first-stage DCI, which may correspond to a second field (or second fields) in the first-stage DCI that is (or are) used for special signaling or notification only, may be used to indicate a special signaling or notification. In other words, the one or more bits of the second field(s) may be a dedicated field(s) or dedicated bit(s) for the special signaling or notification. Accordingly, an indication field(s) in the first-stage DCI for the special signaling or notification may be different from another indication field(s) (e.g. first field) for the type of operation (e.g. sensing, communication, or both). The combination of the one of more bits may indicate one or more of the following special signaling or notification: system information update, a type of warning, a skipping notification on a message, a priority indication on resource usage for at least one of the sensing operation or the communication operation, an indication of a quasi-collocated reference signal, an indication of a transceiver type, a switching indication of the transceiver type, an activation indication of configured or reserved resource usage, a de-activation indication of the configured or reserved resource usage, etc. or a combination thereof.

Alternatively or additionally, the at least one sensing type may comprise: mono-static sensing between a transmitter and a receiver in a UE, bi-static sensing between a UE and a BS or between a UE and a UE, bi-static sensing among a UE, a sensing target and a BS, or among a UE, a sensing target and a UE, multi-static sensing comprising a sensing group configuration for bi-static sensing from more than two participant nodes, or any combination of two or more of the above-mentioned items.

Continuing with reference to FIG. 2A, the first device 201 transmits 216 a second-stage DCI 218 to the second device 202. The second-stage DCI 218 schedules the at least one of the sensing operation or the communication operation. On the other side of the communication, the second device 202 receives 220 the second-stage DCI 218 from the first device 201.

For example, the second-stage DCI may actually schedule transmissions or receptions for sensing and/or communication operations. The second-stage DCI may include information for detecting or decoding the signals of the sensing and/or communication operations. For a communication operation, the second-stage DCI may include an indication on HARQ actions if HARQ-ACK feedback information includes an ACK or a NACK, if HARQ-ACK feedback information includes only NACK, or if there is no feedback of HARQ-ACK information. For sensing operation, the second-stage DCI may optionally include a measurement report from UE or further include a sensing instruction from network. The second-stage DCI may use multiple fields to include information for a sensing operation, a communication operation, or both sensing and communication operations.

In some embodiments, the second-stage DCI may comprise the following information for the at least one of the sensing operation or the communication operation: at least one carrier frequency band, e.g., 6 GHZ, below 6 GHz and above 6 GHz bands; a duplex mode, e.g., TDD or FDD; at least one component carrier associated with at least one channel bandwidth; at least one subcarrier spacing to be used; numerology to be used; an antenna configuration or configuration index, for example, the antenna configuration or the configuration index may include beamforming configuration or index, and the details of the antenna configuration or the configuration index have been provided by RRC; a frequency resource assignment for sensing and/or communication operations, which can be indicated with configured BWPs and BWP indices, and a BWP configured for the sensing operation may be associated with one or more BWPs configured for communication operation; a time resource assignment, for example, time domain patterns may be indicated for a sensing operation, and relative starting or ending time (e.g., symbol, slot, sub-frame, frame) between the two operations may be indicated for both sensing and communication operations; at least one reference frequency domain location; at least one reference time location; at least one sensing type; a transmission or reception direction in a sensing operation; a set of reserved time or frequency resources, for example, a reserved resource may be used by an activation/notification, deactivation, default usage (e.g., reserved or no usage); a resource reservation period, for example, a resource reservation period or indication may be used for a reserved purpose; a DMRS pattern for the communication operation; a sensing signal waveform for the sensing operation; a sensing sequence configuration; a number of at least one DMRS port, an antenna port configuration, a MCS, for example, 5 bits or more bits based on one or more MCS tables that may be indicated in the first-stage DCI or in other message separately; an indicator of a MCS table, for example, an MCS table indicator to be used among one or more MCS tables that are defined, pre-configured or configured by higher layer signaling such as RRC; an indication of one of the sensing operation or the communication operation for which rate matching is to be performed in case of resource usage conflict between the sensing operation and the communication operation, an indication on at least one QCLed RS, a time hopping pattern, a frequency hopping pattern, a HARQ process ID, e.g., a HARQ process number with 4 or more bits; a new data indicator indicating the number of the transmission; an indication that more sensing operations are required; at least one redundancy version for communication, at least one repeatable sensing resource and pattern, at least one zone ID indicating a UE or a target objective zone location, a communication range requirement, a sensing range requirement, a priority of resource usage of one of the sensing operation or the communication operation in case of resource usage conflict between the sensing operation and the communication operation, rate matching for one of the sensing operation or the communication operation, a request for CSI report, or a cast type, or any combination of two or more of the above-mentioned items.

It is to be understood that for scheduling of both sensing and communication operations, the resources and operation parameters may be chosen or indicated from the above listed information. The resources and operation parameters may be scheduled separately as two sets for sensing and communication, respectively; or may be put in a single set where some resources or operation parameters can be common to both sensing and communication operations.

Additionally, the (transmission) cast type may comprise: unicast, multi-cast, broadcast, or any combination of two or more of the above-mentioned items. Alternatively or additionally, the sensing operation may be a sidelink sensing operation, and at least one of the first-stage DCI or the second-stage DCI may comprise at least one of a sensing source ID or a sensing target ID in the sidelink sensing operation. For example, the two-stage DCIs may be applicable to sidelink sensing operations, and the first-stage DCI or the second-stage DCI may include additional information on a sensing source ID and/or a sensing target ID among others in the sidelink(s).

In addition, the first-stage DCI may indicate both the sensing operation and the communication operation to be scheduled, and the sensing operation and the communication operation may be time-aligned and synchronized with a time reference point. For example, sensing and communication operations among a same UE, different UEs, or base stations may be time-aligned and synchronized with a time reference point, e.g., to achieve DL and/or UL synchronization(s), to obtain time advanced (TA) adjustment, etc.

In some embodiments, the first-stage DCI and the second-stage DCI may be carried by two control channels, and the two control channels may be located in a same CORESET or two different CORESETs. In an example, the DCIs from network in such two-stage DCI scheme may be carried by two control channels such as PDCCH channels, and the two control channels may be defined within one configured CORESET region or may be defined in two configured CORESET regions. To avoid or reduce blind detection of the second-stage DCI, location information or a location index on the control channel (e.g., a PDCCH candidate) to carry the second-stage DCI can be provided in the first-stage DCI. If two control channels used to carry the two-stage DCIs are within separate CORESET regions, additional information for CORESET region (or CORESET index) used for transmitting the second-stage DCI may be (i.e., optionally) provided in the first-stage DCI. It is to be understood that the first-stage DCI may be configured in cell-common, group-common or UE specific search space within a CORESET region, and the second-stage DCI may also be configured in cell-common, group-common or UE specific search space within the CORESET region or another CORESET region. Additionally, the first-stage DCI and the second-stage DCI may be time division multiplexed, frequency division multiplexed, or multiplexed in both time domain and frequency domain.

Alternatively, the first-stage DCI may be carried by a control channel, and the second-stage DCI may be carried by a data channel. For example, the first-stage DCI is transmitted in a PDCCH, and the second-stage DCI may be transmitted in a data channel, and the second-stage DCI may be multiplexed with data in the data channel. In this case, the first-stage DCI may schedule the time-frequency resources and associated parameters for the data channel, and optionally include multiplexing parameters for transmissions of the second-stage DCI and the data traffic. The second-stage DCI may either include or not include the time-frequency resources and associated parameters for the data channel depending on the contents indicated the first-stage DCI. In this way, the parameters included in the first-stage DCI may be complemented for transmission of the data traffic.

In some embodiments, the first device 201 may further transmit configuration information to the second device 202. The configuration information indicates a set of configurations for the at least one of the sensing operation or the communication operation. The first-stage DCI and the second-stage DCI indicates at least one configuration for the at least one of the sensing operation or the communication operation among the set of configurations. Additionally, the set of configurations may be transmitted by a RRC message or a MAC CE.

For DCI indications on resources and parameters for sensing and/or communication operations with two-stage DCIs, all or a subset of the above resources and parameters may be pre-configured or configured by higher-layer signaling such as a RRC message or a MAC CE, and then the two DCIs may use the configured resource or parameter indices when applicable for more efficient indications to reduce overhead or DCI payload.

Correspondingly, the second device 202 may further receive configuration information from the first device 201. The configuration information indicates a set of configurations for the at least one of the sensing operation or the communication operation. The first-stage DCI and the second-stage DCI indicates at least one configuration for the at least one of the sensing operation or the communication operation among the set of configurations. Additionally, the set of configurations may be received by an RRC message or a MAC CE.

Alternatively or additionally, the second device 202 may perform at least one of the following after receiving the first-stage DCI and the second-stage DCI: communicating with a BS, communicating with at least one other UE, performing mono-static sensing in an indicated transmission or reception direction, performing bi-static sensing between a UE and a BS or between a UE and a UE, performing bi-static sensing in an indicated transmission or reception direction among a UE, a sensing target and a BS, or among a UE, a sensing target and a UE, performing multi-static sensing in an indicated transmission or reception direction among a UE, a sensing target and a BS, or among a UE, a sensing target and a UE, wherein a sensing source ID or a sensing reception ID may be included in the at least one of the first-stage DCI or the second-stage DCI.

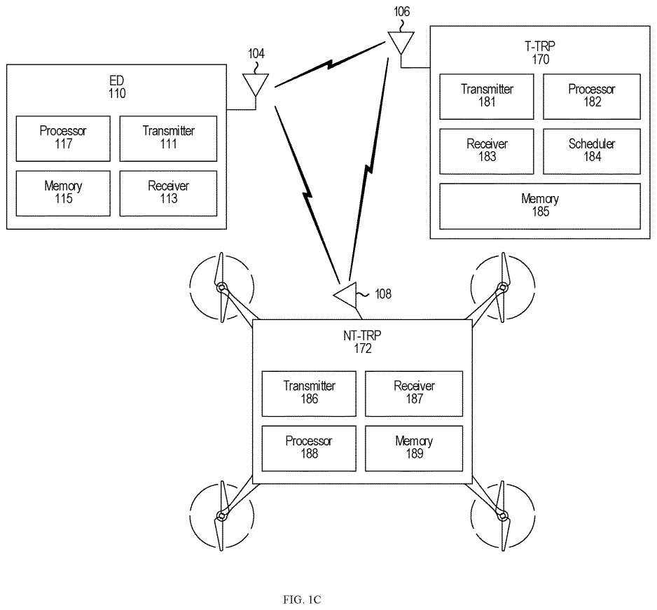

FIG. 3 illustrates an example of two-stage DCIs for a sensing operation according to some embodiments of the present disclosure. As shown in FIG. 3, the 1^{st} DCI, i.e., the first stage DCI, indicates a sensing operation to be scheduled in 2^{nd} DCI, i.e., the second stage DCI, with a DCI format. The DCI format may be defined by standards, pre-configured or configured by RRC, MAC-CE, etc. The 2^{nd} DCI schedules time-frequency (T-F) resources and associated one or more parameters described above for the sensing operation. For example, the 2^{nd} DCI may include scheduling information, including sensing T-F resources such as S1, S2, time transmission (TX) or reception (RX) pattern(s), time and/or frequency hopping pattern(s), sensing waveforms, a frequency band for the sensing operation, a BWP or a BWP index, etc. Moreover, one or more sensing types among multiple sensing types such as mono-static sensing, bi-static sensing, multi-static sensing, etc., can be indicated. The sensing operation may be performed between a UE-base station, different UEs, a same UE (i.e., for mono-static sensing), UE-sensing target(s), BS-sensing target(s), or a combination of these sensing pairs as a sensing group. In some embodiments, the two-stage DCIs may be applicable to side link sensing operations where the indication may include additional information on a sensing source ID and/or a sensing target ID among others in the side-link(s).

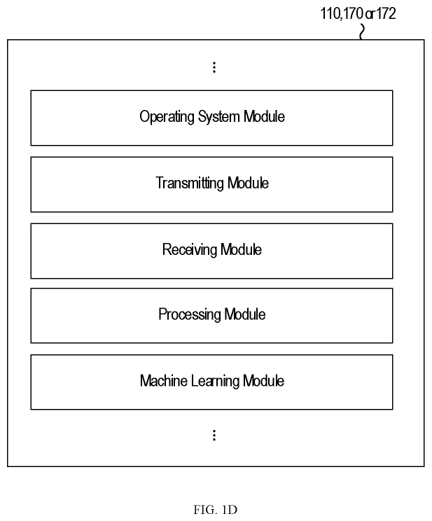

FIG. 4 illustrates an example of two-stage DCIs for a communication operation according to some embodiments of the present disclosure. Similar to the sensing operation, the 1^{st} DCI, i.e., the first stage DCI, indicates a communication operation to be scheduled in 2^{nd} DCI, i.e., the second stage DCI, with a DCI format. The 2^{nd} DCI schedules T-F resources and associated one or more parameters described above for the communication operation. For example, the 2^{nd} DCI may include scheduling information, including communication T-F resources such as C1, C2, TX or RX time and/or frequency pattern(s), time and/or frequency hopping pattern(s), sensing waveforms, a frequency band for the communication operation, a BWP or a BWP index, etc.

Reference is now made to FIG. 2B, which illustrates another example signaling chart illustrating an example process according to some embodiments of the present disclosure. The process 200B may involve a first device 201 and a second device 202. The first device 201 in FIG. 2B may be an example of the network node 170 in FIG. 1A. The second device 202 in FIG. 2B may be an example of the communication electric device 110 in FIG. 1A. It would be appreciated that although the process flow 200B has been described in the communication system 100A of FIG. 1A, this process may be likewise applied to other communication scenarios.

In the process flow 200B, the first device 201 transmits 230 a first-stage DCI 232 to the second device 202. The first-stage DCI 232 indicates a sensing operation and a communication operation to be scheduled. On the other side of the communication, the second device 202 receives 234 the first-stage DCI 232 from the first device 201. In other words, the two-stage DCIs indicates both sensing and communication operations with resources and parameters configurations. Additionally, the first-stage DCI may further comprise a DCI format of the second-stage DCI. The DCI format may be defined by standards, pre-configured or configured by a RRC message, or a MAC-CE, etc.

Continuing with reference to FIG. 2B, the first device 201 transmits 236 a second-stage DCI 238 to the second device 202. The second-stage DCI 238 schedules the sensing operation and the communication operation. On the other side of the communication, the second device 202 receives 240 the second-stage DCI 238 from the first device 201. The second stage DCI schedules T-F resources and related one or more parameters for the sensing and communication operations.

In some embodiments, the second-stage DCI may comprise the following information for the sensing operation: a frequency resource assignment, a time resource assignment, a transmission or reception direction, a time hopping pattern, a frequency hopping pattern, a sensing signal waveform, at least one carrier frequency band, at least one bandwidth part, or at least one sensing type, or any combination of two or more of the above-mentioned items.

In an example, for sensing operations, the second stage DCI may include scheduling information such as sensing T-F resources, time transmission or reception pattern(s), time and/or frequency hopping pattern(s), sensing waveforms, a sensing operation frequency band, a BWP or a BWP index, etc.

Additionally, the at least one sensing type may comprise: mono-static sensing between a transmitter and a receiver in a UE, bi-static sensing between a UE and a BS or between a UE and a UE, bi-static sensing among a UE, a sensing target and a BS, or among a UE, a sensing target and a UE, multi-static sensing comprising a sensing group configuration for bi-static sensing from more than two participant nodes, or any combination of two or more of the above-mentioned items. For example, one or more sensing types among multiple sensing types such as mono-static sensing, bi-static sensing, multi-static sensing, etc., may be indicated. The sensing operation may be performed between a UE-base station, different UEs, a same UE (i.e., for mono-static sensing), UE-sensing target(s), BS-sensing target(s), or a combination of these sensing pairs as a sensing group.

In some embodiments, the second-stage DCI may comprise the following information for the communication operation: a frequency resource assignment, a time resource assignment, a transmission or reception direction, a time hopping pattern, a frequency hopping pattern, a signal waveform, at least one carrier frequency band, or at least one bandwidth part, or any combination of two or more of the above-mentioned items.

In an example, for communication operations, the second stage DCI may include scheduling information, such as communication T-F resources, time transmission or reception pattern(s), time and/or frequency hopping pattern(s), signal waveforms, an operation frequency band, a BWP or a BWP index, etc.

Alternatively or additionally, the sensing operation may be a sidelink sensing operation, and at least one of the first-stage DCI or the second-stage DCI may comprise at least one of a sensing source ID or a sensing target ID in the sidelink sensing operation. For instance, the two-stage DCI schemes may be applicable to side link communication operations by adding a sidelink source ID and/or a sidelink target ID among others.

In addition, one of the first-stage DCI or the second-stage DCI may further comprise an indication of one of the sensing operation or the communication operation for which rate matching is to be performed in case of resource usage conflict between the sensing operation and the communication operation, a priority of resource usage of one of the sensing operation or the communication operation in case of resource usage conflict between the sensing operation and the communication operation, an indication on at least one QCLed RS, a configuration for split beams or shared beams, a configuration for split antennas, or any combination of two or more of the above-mentioned items.

In an example, allocated resources between the communication operation and the sensing operation may be overlapped that may lead to resource usage conflicts. Moreover, one operation signal such as reference signal may be beneficial to the other operation for signal detection or measurement. As a result, an indication of rate matching among sensing and communication with a priority in resource usage and/or a QCL reference signal configuration may be included in one of the two-stage DCIs. In addition, split antennas/beams or shared beams may be configured for sensing and communication operations, and the shared beams may be configured with a duplex mode (e.g., TDD, FDD, etc.), rate matching or muting setup.

In some embodiments, the sensing operation and the communication operation may be time-aligned and synchronized with a time reference point. Additionally, the first-stage DCI and the second-stage DCI may be time division multiplexed, frequency division multiplexed, or multiplexed in both time domain and frequency domain.

Alternatively or additionally, the first device 201 may transmit configuration information to the second device 202. The configuration information may indicate a set of configurations for the sensing operation and the communication operation, and the first-stage DCI and the second-stage DCI indicates at least one configuration for the sensing operation and the communication operation among the set of configurations. Additionally, the set of configurations may be transmitted by an RRC message or a MAC CE.

Correspondingly, the second device 202 may receive configuration information from the first device 201. The configuration information may indicate a set of configurations for the sensing operation and the communication operation, and the first-stage DCI and the second-stage DCI indicates at least one configuration for the sensing operation and the communication operation among the set of configurations. Additionally, the set of configurations may be received by a RRC message or a MAC CE.

Alternatively or additionally, the second device 202 may further perform at least one of the following after receiving the first-stage DCI and the second-stage DCI: communicating with a BS, communicating with at least one other UE, performing mono-static sensing in an indicated transmission or reception direction, performing bi-static sensing between a UE and a BS or between a UE and a UE, performing bi-static sensing in an indicated transmission or reception direction among a UE, a sensing target and a BS, or among a UE, a sensing target and a UE, performing multi-static sensing in an indicated transmission or reception direction among a UE, a sensing target and a BS, or among a UE, a sensing target and a UE, wherein a sensing source ID or a sensing reception ID may be included in the at least one of the first-stage DCI or the second-stage DCI.

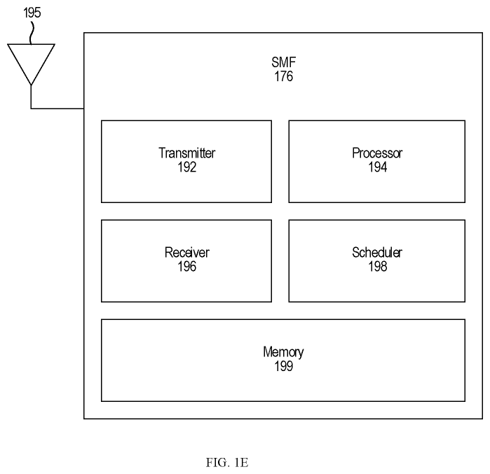

FIG. 5 illustrates an example of two-stage DCIs for sensing and communication operations according to some embodiments of the present disclosure. As shown in FIG. 5, the 1^{st} DCI indicates the sensing and communication operations to be scheduled in the second DCI and the associated second stage DCI format to be used. The 2^{nd} DCI schedules T-F resources and associated one or more parameters for sensing and communication operations. For example, the second stage DCI may include scheduling information, including communication T-F resources such as C, TX or RX time and/or frequency parameters, sensing T-F resources such as S, TX patterns, sensing waveforms, etc.

Reference is now made to FIG. 2C which illustrates a signaling chart illustrating an example process according to some embodiments of the present disclosure. The process 200C may involve a first device 201 and a second device 202. The first device 201 in FIG. 2C may be an example of the network node 170 in FIG. 1A. The second device 202 in FIG. 2C may be an example of the communication electric device 110 in FIG. 1A. It would be appreciated that although the process flow 200C has been described in the communication system 100A of FIG. 1A, this process may be likewise applied to other communication scenarios.

In the process flow 200C, the first device 201 transmits 250 configuration information 252 to the second device 202. The configuration information 252 indicates a set of configurations for sensing operations. On the other side of the communication, the second device 202 receives 254 the configuration information 252 from the first device 201.

Continuing with reference to FIG. 2C, the first device 201 transmits 256 a dedicated DCI 258 to the second device 202. The dedicated DCI 258 schedules a sensing operation and indicates at least one configuration for the sensing operation among the set of configurations. On the other side of the communication, the second device 202 receives 260 the dedicated DCI 258 from the first device 201. The dedicated DCI may provide the sensing operation with required resources and one or more of related parameters for the sensing operation that can be same as described in FIG. 2A or FIG. 2B.

In some embodiments, the at least one configuration may comprise at least one of the following information: at least one carrier frequency band, a duplex mode, at least one component carrier associated with at least one channel bandwidth, at least one subcarrier spacing to be used, an antenna configuration, a frequency resource assignment, a time resource assignment, at least one reference frequency domain location, at least one reference time location, at least one sensing type, a transmission or reception direction in a sensing operation, a set of reserved time or frequency resources, a resource reservation period, a sensing signal waveform, a sensing sequence configuration, a number of at least one DMRS port, an antenna port configuration, a MCS, an indicator of a MCS table, an indication on at least one QCLed RS, a time hopping pattern, a frequency hopping pattern, a HARQ process ID, a new data indicator, an indication that more sensing operations are required, at least one redundancy version for repeatable sensing resources, at least one patterns for repeatable sensing resources, at least one zone ID, at least one range requirement, a request for CSI report, a cast type, or any combination of two or more of the above-mentioned items. Additionally, the cast type may comprise at least one of the following: unicast, multi-cast, or broadcast.

Alternatively or additionally, the at least one configuration may indicate a sensing occasion comprising at least one sensing waveform, at least one time-frequency resource area, at least one carrier frequency, at least one BWP (in one component carrier or different component carriers), at least one time-frequency hopping pattern, and at least one subcarrier spacing. In addition, multiple time-frequency patterns in the sensing occasion may be different in time-frequency resources and hopping patterns. Additionally, the time-frequency resources and the hopping patterns may be indexed.

In some embodiments, the at least one configuration may indicate a time point when a sensing occasion starts, at least one time-frequency resource to be used, which is indexed using at least one resource index, at least one hopping pattern to be used, which is indexed using at least one hopping pattern index, at least one carrier frequency band, at least one component carrier, or any combination of two or more of the above-mentioned items. Additionally, the set of configurations may be transmitted by a RRC message or a MAC CE.

For instance, the dedicated DCI signaling for the sensing operation can simplify the DCI format or DCI payload information. The sensing operation may be associated with simplified transmission or reception signals as compared to communication signals. In addition, the sensing operation may have repeatable and periodic patterns for the configurations on starting time, ending time, active duration, and periodicity. The dedicated DCI field may have reduced bits for the indication on when a sensing occasion starts, which time-frequency resources and/or hopping patterns to use with a configured resource index and/or a hopping pattern index. Moreover, a carrier frequency band and/or a component carrier can be dynamically indicated.

Continuing with reference to FIG. 2C, based on the dedicated DCI, the second device 202 performs 262 the sensing operation. For instance, performing the sensing operation may comprise: performing mono-static sensing in an indicated transmission or reception direction, performing bi-static sensing between a UE and a BS or between a UE and a UE, performing bi-static sensing in an indicated transmission or reception direction among a UE, a sensing target and a BS, or among a UE, a sensing target and a UE, performing multi-static sensing in an indicated transmission or reception direction among a UE, a sensing target and a BS, or among a UE, a sensing target and a UE, and a sensing source ID or a sensing reception ID may be included in the dedicated DCI.

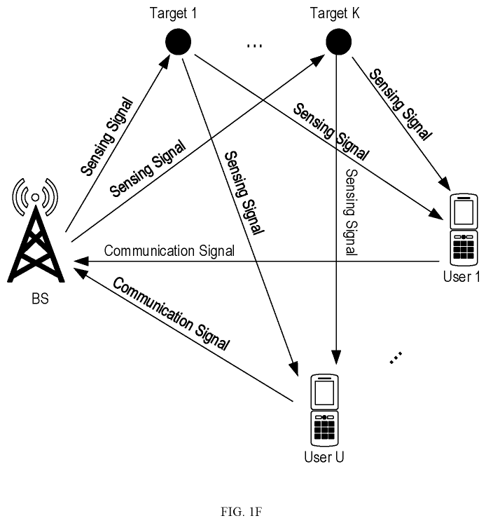

FIG. 6 illustrates an example of a dedicated DCI signaling for a sensing operation according to some embodiments of the present disclosure. As shown in FIG. 6, the dedicated DCI may indicate sensing time-frequency resources (e.g., S1, S2), hopping patterns, waveforms, or indices to these resources or parameters that are pre-configured or configured by a higher-layer signaling such as a RRC message or a MAC CE.

In view of the above, a detection on a DCI in PDCCH channel may involve blind detection over multiple PDCCH candidates where the DCI can be varying in size depending on its format, such as a DCI format for DL, UL, etc. It is expected that a DCI that allocate resources and parameters for one sensing operation only, one communication only or both sensing and communication operations may have a different message payload. As a result, one way for a shared DCI signaling can be designed in two stages, the first-stage DCI may comprise information to indicate which operation(s) to be scheduled, and the second-stage DCI may comprise a configuration of time-frequency resource(s) and associated operation parameters.

The first-stage DCI may include one or more of the following information: which operation to be scheduled, and at least two bits can be used for this indication; at least one time-frequency resource allocation or at least one resource index on at least one PDCCH location for a transmission of the second-stage DCI; a priority of resource usage; a rate matching indication for the sensing and/or communication operation.

The second-stage DCI may include one or more of the following information: at least one time-frequency resource allocation or resource index for the sensing operation, the communication operation or both sensing and communication operations; associated operation parameters for transmissions or receptions comprising one or more of at least one carrier frequency band, at least one component carrier, at least one bandwidth part, numerology, signal waveforms, at least one reference signal, at least one transceiver type, etc.; at least one sensing type, such as mono-static sensing, bi-static sensing or multi-static sensing operation, and/or signal patterns to be transmitted or received; signal measurement metrics and/or a measurement configuration (or indication by index or indices); a resource usage priority, an rate matching indication for the sensing and/or communication operations; QCL reference signals.

In addition, a dedicated signaling may be designed for a sensing operation separate from a communication operation. A new DCI format for the sensing indication is needed. As sensing operation configuration may be simpler than communication operation in the sense of signal structure, the new DCI format may have smaller payload information, which may reduce the DCI overhead.

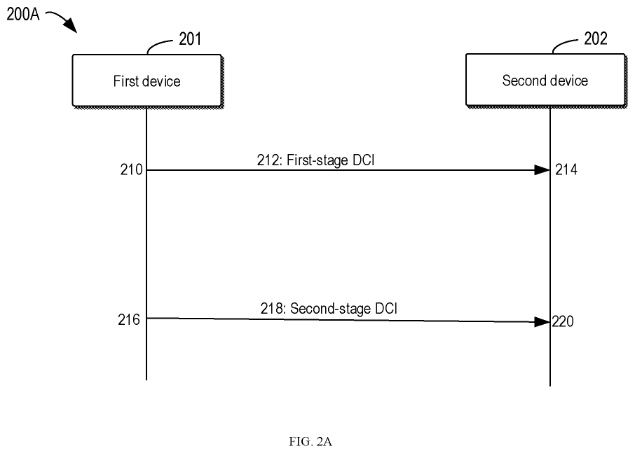

FIG. 7 shows a flowchart of an example method 700 implemented at a first device in accordance with some embodiments of the present disclosure. For the purpose of discussion, the method 700 will be described from the perspective of the first device 201 with reference to FIG. 2A. It is to be understood that the method 700 may include additional acts not shown and/or may omit some shown acts, and the scope of the present disclosure is not limited in this regard.

At block 710, the first device transmits a first-stage downlink control information (DCI) for indicating at least one of a sensing operation or a communication operation to be scheduled. At block 720, the first device transmits a second-stage DCI for scheduling the at least one of the sensing operation or the communication operation. It should be noted that the method 700 may further include various other operations which may be performed by the first device 201 as described above with reference to the signaling process 200A of FIG. 2A.

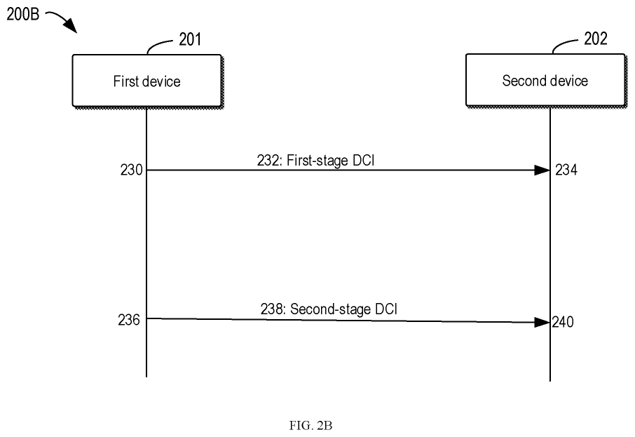

FIG. 8 shows a flowchart of an example method 800 implemented at a second device in accordance with some embodiments of the present disclosure. For the purpose of discussion, the method 800 will be described from the perspective of second device 202 with reference to FIG. 2A. It is to be understood that the method 800 may include additional acts not shown and/or may omit some shown acts, and the scope of the present disclosure is not limited in this regard.

At block 810, the second device receives a first-stage downlink control information (DCI) indicating that at least one of a sensing operation or a communication operation is to be scheduled. At block 820, the second device receives a second-stage DCI for scheduling the at least one of the sensing operation or the communication operation. It should be noted that the method 800 may further include various other operations which may be performed by the second device 202 as described above with reference to the signaling process 200A of FIG. 2A.

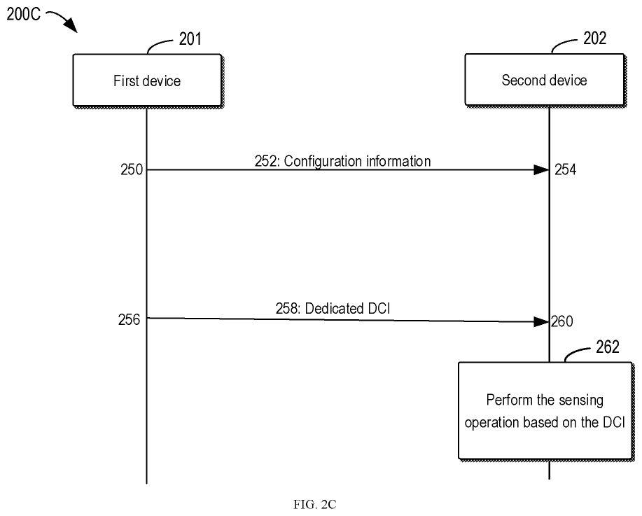

FIG. 9 shows a flowchart of an example method 900 implemented at a first device in accordance with some embodiments of the present disclosure. For the purpose of discussion, the method 900 will be described from the perspective of first device 201 with reference to FIG. 2B. It is to be understood that the method 900 may include additional acts not shown and/or may omit some shown acts, and the scope of the present disclosure is not limited in this regard.

At block 910, the first device transmits a first-stage downlink control information (DCI) for indicating a sensing operation and a communication operation to be scheduled. At block 920, the first device transmits a second-stage DCI for scheduling the sensing operation and the communication operation. It should be noted that the method 900 may further include various other operations which may be performed by the first device 201 as described above with reference to the signaling process 200B of FIG. 2B.

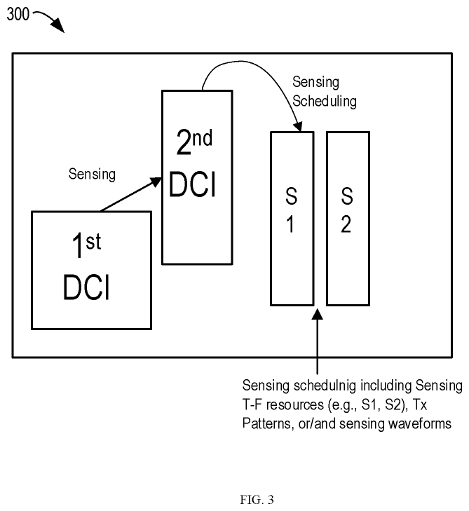

FIG. 10 shows a flowchart of an example method 1000 implemented at a second device in accordance with some embodiments of the present disclosure. For the purpose of discussion, the method 1000 will be described from the perspective of second device 202 with reference to FIG. 2B. It is to be understood that the method 1000 may include additional acts not shown and/or may omit some shown acts, and the scope of the present disclosure is not limited in this regard.

At block 1010, the second device receives a first-stage downlink control information (DCI) for indicating a sensing operation and a communication operation to be scheduled. At block 1020, the second device receives a second-stage DCI for scheduling the sensing operation and the communication operation. It should be noted that the method 1000 may further include various other operations which may be performed by the second device 202 as described above with reference to the signaling process 200B of FIG. 2B.

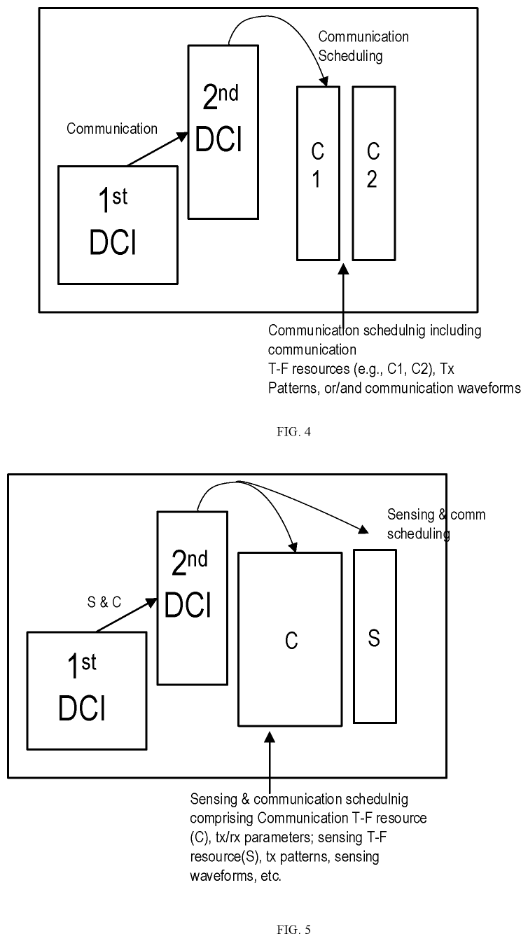

FIG. 11 shows a flowchart of an example method 1100 implemented at a first device in accordance with some embodiments of the present disclosure. For the purpose of discussion, the method 1100 will be described from the perspective of first device 201 with reference to FIG. 2C. It is to be understood that the method 1100 may include additional acts not shown and/or may omit some shown acts, and the scope of the present disclosure is not limited in this regard.

At block 1110, the first device transmits configuration information indicating a set of configurations for sensing operations. At block 1120, the first device transmits a dedicated downlink control information (DCI) scheduling a sensing operation and indicating, among the set of configurations, at least one configuration for the sensing operation. It should be noted that the method 1100 may further include various other operations which may be performed by the first device 201 as described above with reference to the signaling process 200C of FIG. 2C.

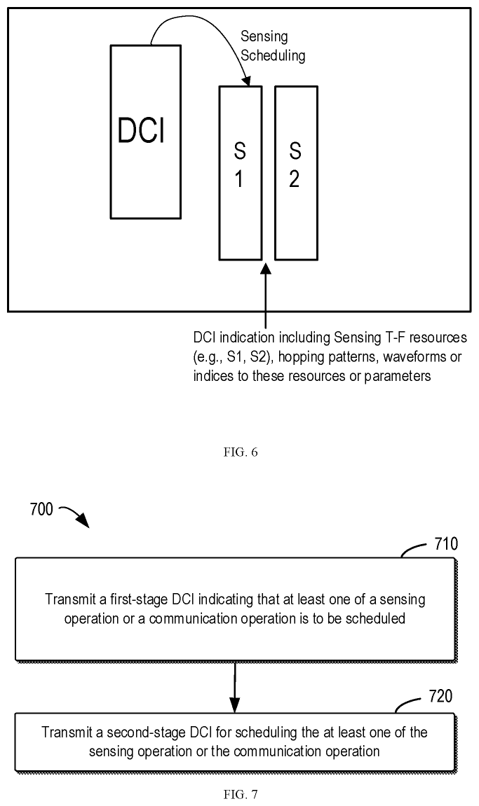

FIG. 12 shows a flowchart of an example method 1200 implemented at a second device in accordance with some embodiments of the present disclosure. For the purpose of discussion, the method 1200 will be described from the perspective of second device 202 with reference to FIG. 2C. It is to be understood that the method 1200 may include additional acts not shown and/or may omit some shown acts, and the scope of the present disclosure is not limited in this regard.

At block 1210, the second device receives configuration information indicating a set of configurations for sensing operations. At block 1220, the second device receives a dedicated downlink control information (DCI) scheduling a sensing operation and indicating, among the set of configurations, at least one configuration for the sensing operation. At block 1230, the second device performs the sensing operation based on the dedicated DCI. It should be noted that the method 1200 may further include various other operations which may be performed by the second device 202 as described above with reference to the signaling process 200C of FIG. 2C.

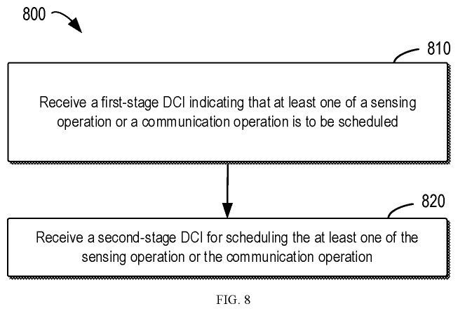

FIG. 13 is a block diagram of a device 1300 that may be used for implementing some embodiments of the present disclosure. In some embodiments, the device 1300 may be an element of communications network infrastructure, such as a base station (for example, a NodeB, an evolved Node B (eNodeB, or eNB), a next generation NodeB (sometimes referred to as a gNodeB or gNB), a home subscriber server (HSS), a gateway (GW) such as a packet gateway (PGW) or a serving gateway (SGW) or various other nodes or functions within a core network (CN) or a Public Land Mobility Network (PLMN). In other embodiments, the device 1300 may be a device that connects to the network infrastructure over a radio interface, such as a mobile phone, smart phone or other such device that may be classified as a User Equipment (UE). In some embodiments, the device 1300 may be a Machine Type Communications (MTC) device (also referred to as a machine-to-machine (M2M) device), or another such device that may be categorized as a UE despite not providing a direct service to a user. In some embodiments, the device 1300 may be a road side unit (RSU), a vehicle UE (V-UE), pedestrian UE (P-UE) or an infrastructure UE (I-UE). In some scenarios, the device 1300 may also be referred to as a mobile device, a term intended to reflect devices that connect to mobile network, regardless of whether the device itself is designed for, or capable of, mobility. Specific devices may utilize all of the components shown or only a subset of the components, and levels of integration may vary from device to device. Furthermore, the device 1300 may contain multiple instances of a component, such as multiple processors, memories, transmitters, receivers, etc.

The device 1300 typically includes a processor 1302, such as a Central Processing Unit (CPU), and may further include specialized processors such as a Graphics Processing Unit (GPU) or other such processor, a memory 1304, a network interface 1306 and a bus 1308 to connect the components of the device 1300. The device 1300 may optionally also include components such as a mass storage device 1310, a video adapter 1312, and an I/O interface 1316 (shown in dashed lines).

The memory 1304 may comprise any type of non-transitory system memory, readable by the processor 1302, such as static random access memory (SRAM), dynamic random access memory (DRAM), synchronous DRAM (SDRAM), read-only memory (ROM), or a combination thereof. In an embodiment, the memory 1304 may include more than one type of memory, such as ROM for use at boot-up, and DRAM for program and data storage for use while executing programs. The bus 1308 may be one or more of any type of several bus architectures including a memory bus or memory controller, a peripheral bus, or a video bus.

The device 1300 may also include one or more network interfaces 1306, which may include at least one of a wired network interface and a wireless network interface. As illustrated in FIG. 13, network interface 1306 may include a wired network interface to connect to a network 1322, and also may include a radio access network interface 1320 for connecting to other devices over a radio link. When the device 1300 is a network infrastructure element, the radio access network interface 1320 may be omitted for nodes or functions acting as elements of the PLMN other than those at the radio edge (e.g., an eNB). When the device 1300 is infrastructure at the radio edge of a network, both wired and wireless network interfaces may be included. When the device 1300 is a wirelessly connected device, such as a User Equipment, radio access network interface 1320 may be present and it may be supplemented by other wireless interfaces such as WiFi network interfaces. The network interfaces 1306 allow the device 1300 to communicate with remote entities such as those connected to network 1322.

The mass storage 1310 may comprise any type of non-transitory storage device configured to store data, programs, and other information and to make the data, programs, and other information accessible via the bus 1308. The mass storage 1310 may comprise, for example, one or more of a solid state drive, hard disk drive, a magnetic disk drive, or an optical disk drive. In some embodiments, the mass storage 1310 may be remote to the device 1300 and accessible through use of a network interface such as interface 1306. In the illustrated embodiment, the mass storage 1310 is distinct from memory 1304 where it is included, and may generally perform storage tasks compatible with higher latency, but may generally provide lesser or no volatility. In some embodiments, the mass storage 1310 may be integrated with a heterogeneous memory 1304.

The optional video adapter 1312 and the I/O interface 1316 (shown in dashed lines) provide interfaces to couple the device 1300 to external input and output devices. Examples of input and output devices include a display 1314 coupled to the video adapter 1312 and an I/O device 1318 such as a touch-screen coupled to the I/O interface 1316. Other devices may be coupled to the device 1300, and additional or fewer interfaces may be utilized. For example, a serial interface such as Universal Serial Bus (USB) (not shown) may be used to provide an interface for an external device. Those skilled in the art will appreciate that in embodiments in which the device 1300 is part of a data center, I/O interface 1316 and Video Adapter 1312 may be virtualized and provided through network interface 1306.

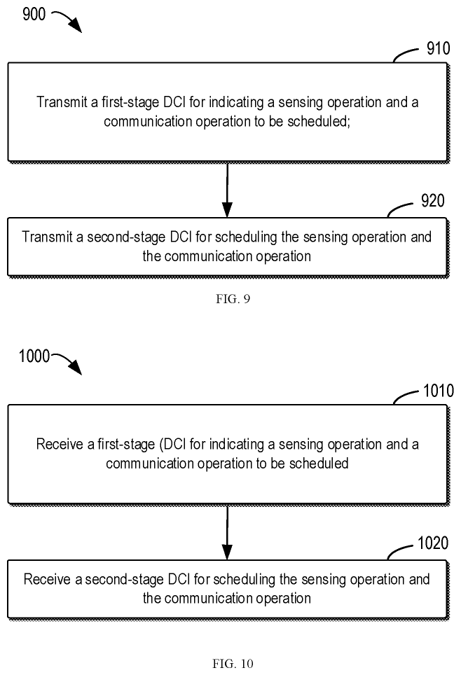

FIG. 14 is a schematic diagram of a structure of an apparatus 1400 in accordance with some embodiments of the present disclosure. As shown in FIG. 14, the apparatus 1400 includes a transmitting unit 1402, and a transmitting unit 1404. The apparatus 1400 may be applied to the communication system as shown in FIG. 1A, and may implement any of the methods provided in the foregoing embodiments. Optionally, a physical representation form of the apparatus 1400 may be a communication device, for example, a network device or UE. Alternatively, the apparatus 1400 may be another apparatus that can implement a function of a communication device, for example, a processor or a chip inside the communication device. Specifically, the apparatus 1400 may be some programmable chips such as a field-programmable gate array (field-programmable gate array, FPGA), a complex programmable logic device (complex programmable logic device, CPLD), an application-specific integrated circuit (application-specific integrated circuits, ASIC), or a system on a chip (System on a chip, SOC).

In some embodiments, the transmitting unit 1402 may be configured to transmit a first-stage downlink control information (DCI) indicating that at least one of a sensing operation or a communication operation is to be scheduled. The transmitting unit 1404 may be configured to transmit a second-stage DCI for scheduling the at least one of the sensing operation or the communication operation.

In some other embodiments, the apparatus 1400 can include various other units or modules which may be configured to perform various operations or functions as described in connection with the foregoing method embodiments. The details can be obtained referring to the detailed description of the foregoing method embodiments and are not described herein again.

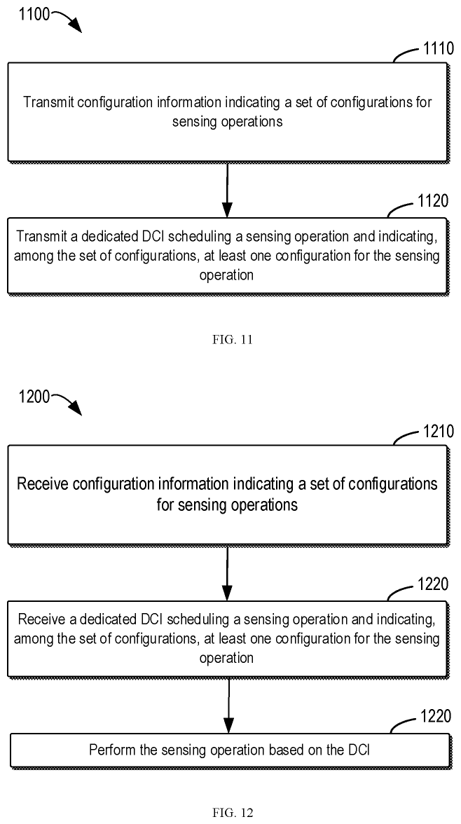

FIG. 15 is a schematic diagram of a structure of an apparatus 1500 in accordance with some embodiments of the present disclosure. As shown in FIG. 15, the apparatus 1500 includes a receiving unit 1502, and a receiving unit 1504. The apparatus 1500 may be applied to the communication system as shown in FIG. 1A, and may implement any of the methods provided in the foregoing embodiments. Optionally, a physical representation form of the apparatus 1500 may be a communication device, for example, a network device or UE. Alternatively, the apparatus 1500 may be another apparatus that can implement a function of a communication device, for example, a processor or a chip inside the communication device. Specifically, the apparatus 1500 may be some programmable chips such as a field-programmable gate array (field-programmable gate array, FPGA), a complex programmable logic device (complex programmable logic device, CPLD), an application-specific integrated circuit (application-specific integrated circuits, ASIC), or a system on a chip (System on a chip, SOC).

In some embodiments, the receiving unit 1502 may be configured to receive a first-stage downlink control information (DCI) indicating that at least one of a sensing operation or a communication operation is to be scheduled. The receiving unit 1504 may be configured to receive a second-stage DCI for scheduling the at least one of the sensing operation or the communication operation.

In some other embodiments, the apparatus 1500 can include various other units or modules which may be configured to perform various operations or functions as described in connection with the foregoing method embodiments. The details can be obtained referring to the detailed description of the foregoing method embodiments and are not described herein again.

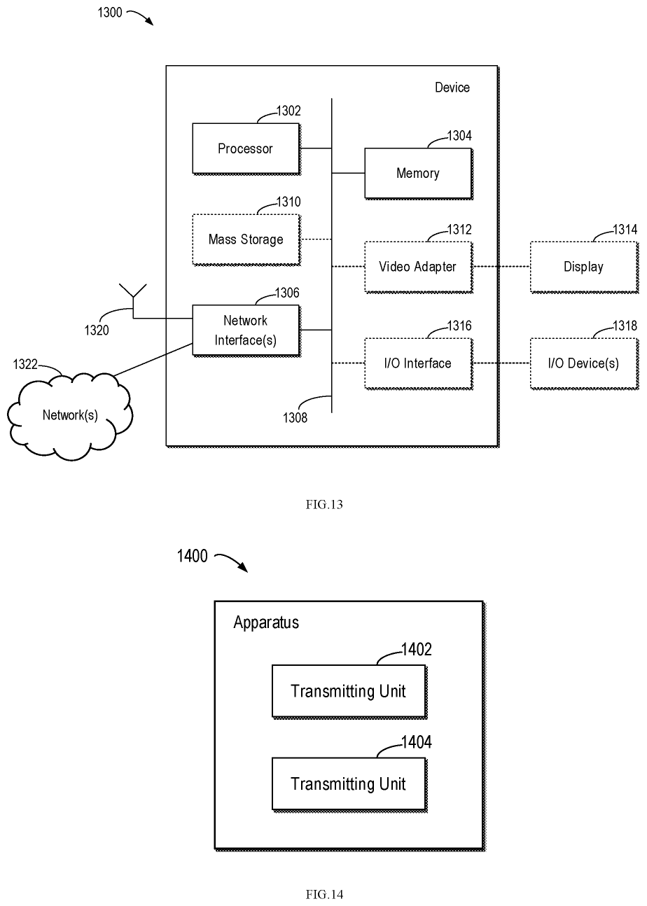

FIG. 16 is a schematic diagram of a structure of an apparatus 1600 in accordance with some embodiments of the present disclosure. As shown in FIG. 16, the apparatus 1600 includes a transmitting unit 1602, and a transmitting unit 1604. The apparatus 1600 may be applied to the communication system as shown in FIG. 1A, and may implement any of the methods provided in the foregoing embodiments. Optionally, a physical representation form of the apparatus 1600 may be a communication device, for example, a network device or UE. Alternatively, the apparatus 1600 may be another apparatus that can implement a function of a communication device, for example, a processor or a chip inside the communication device. Specifically, the apparatus 1600 may be some programmable chips such as a field-programmable gate array (field-programmable gate array, FPGA), a complex programmable logic device (complex programmable logic device, CPLD), an application-specific integrated circuit (application-specific integrated circuits, ASIC), or a system on a chip (System on a chip, SOC).

In some embodiments, the transmitting unit 1602 may be configured to transmit a first-stage downlink control information (DCI) for indicating a sensing operation and a communication operation to be scheduled. The transmitting unit 1604 may be configured to transmit a second-stage DCI for scheduling the sensing operation and the communication operation.

In some other embodiments, the apparatus 1600 can include various other units or modules which may be configured to perform various operations or functions as described in connection with the foregoing method embodiments. The details can be obtained referring to the detailed description of the foregoing method embodiments and are not described herein again.

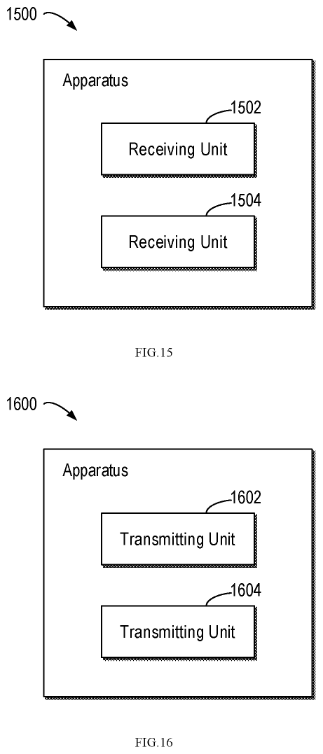

FIG. 17 is a schematic diagram of a structure of an apparatus 1700 in accordance with some embodiments of the present disclosure. As shown in FIG. 17, the apparatus 1700 includes a receiving unit 1702, and a receiving unit 1704. The apparatus 1700 may be applied to the communication system as shown in FIG. 1A, and may implement any of the methods provided in the foregoing embodiments. Optionally, a physical representation form of the apparatus 1700 may be a communication device, for example, a network device or UE. Alternatively, the apparatus 1700 may be another apparatus that can implement a function of a communication device, for example, a processor or a chip inside the communication device. Specifically, the apparatus 1700 may be some programmable chips such as a field-programmable gate array (field-programmable gate array, FPGA), a complex programmable logic device (complex programmable logic device, CPLD), an application-specific integrated circuit (application-specific integrated circuits, ASIC), or a system on a chip (System on a chip, SOC).

In some embodiments, the receiving unit 1702 may be configured to receive a first-stage downlink control information (DCI) for indicating a sensing operation and a communication operation to be scheduled. The receiving unit 1704 may be configured to receive a second-stage DCI for scheduling the sensing operation and the communication operation.

In some other embodiments, the apparatus 1700 can include various other units or modules which may be configured to perform various operations or functions as described in connection with the foregoing method embodiments. The details can be obtained referring to the detailed description of the foregoing method embodiments and are not described herein again.

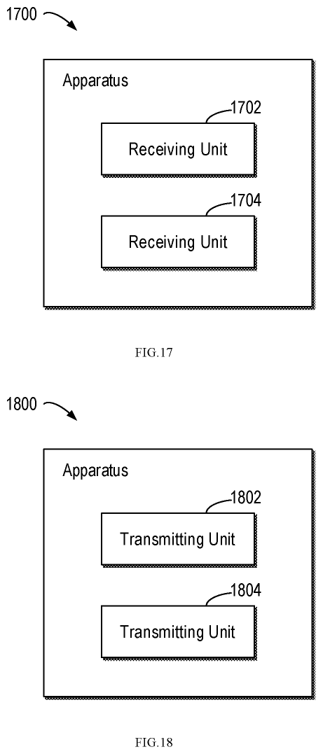

FIG. 18 is a schematic diagram of a structure of an apparatus 1800 in accordance with some embodiments of the present disclosure. As shown in FIG. 18, the apparatus 1800 includes a transmitting unit 1802, and a transmitting unit 1804. The apparatus 1800 may be applied to the communication system as shown in FIG. 1A, and may implement any of the methods provided in the foregoing embodiments. Optionally, a physical representation form of the apparatus 1800 may be a communication device, for example, a network device or UE. Alternatively, the apparatus 1800 may be another apparatus that can implement a function of a communication device, for example, a processor or a chip inside the communication device. Specifically, the apparatus 1800 may be some programmable chips such as a field-programmable gate array (field-programmable gate array, FPGA), a complex programmable logic device (complex programmable logic device, CPLD), an application-specific integrated circuit (application-specific integrated circuits, ASIC), or a system on a chip (System on a chip, SOC).

In some embodiments, the transmitting unit 1802 may be configured to transmit configuration information indicating a set of configurations for sensing operations. The transmitting unit 1804 may be configured to transmit a dedicated downlink control information (DCI) scheduling a sensing operation and indicating, among the set of configurations, at least one configuration for the sensing operation.

In some other embodiments, the apparatus 1800 can include various other units or modules which may be configured to perform various operations or functions as described in connection with the foregoing method embodiments. The details can be obtained referring to the detailed description of the foregoing method embodiments and are not described herein again.

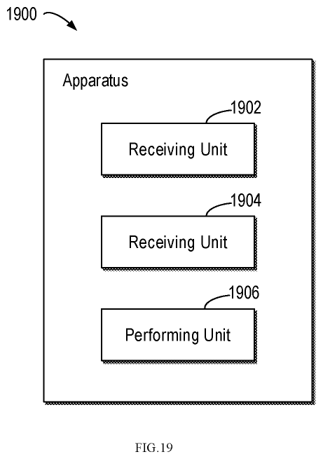

FIG. 19 is a schematic diagram of a structure of an apparatus 1900 in accordance with some embodiments of the present disclosure. As shown in FIG. 19, the apparatus 1900 includes a receiving unit 1902, a receiving unit 1904, and a performing unit 1906. The apparatus 1900 may be applied to the communication system as shown in FIG. 1A, and may implement any of the methods provided in the foregoing embodiments. Optionally, a physical representation form of the apparatus 1900 may be a communication device, for example, a network device or UE. Alternatively, the apparatus 1900 may be another apparatus that can implement a function of a communication device, for example, a processor or a chip inside the communication device. Specifically, the apparatus 1900 may be some programmable chips such as a field-programmable gate array (field-programmable gate array, FPGA), a complex programmable logic device (complex programmable logic device, CPLD), an application-specific integrated circuit (application-specific integrated circuits, ASIC), or a system on a chip (System on a chip, SOC).

In some embodiments, the receiving unit 1902 may be configured to receive configuration information indicating a set of configurations for sensing operations. The receiving unit 1904 may be configured to receive a dedicated downlink control information (DCI) scheduling a sensing operation and indicating, among the set of configurations, at least one configuration for the sensing operation. The performing unit 1906 may be configured to perform the sensing operation based on the dedicated DCI.

In some other embodiments, the apparatus 1900 can include various other units or modules which may be configured to perform various operations or functions as described in connection with the foregoing method embodiments. The details can be obtained referring to the detailed description of the foregoing method embodiments and are not described herein again.

It should be noted that division into the units or modules in the foregoing embodiments of the present disclosure is an example, and is merely logical function division. In actual implementation, there may be another division manner. In addition, function units in embodiments of the present disclosure may be integrated into one processing unit, or may exist alone physically, or two or more units may be integrated into one unit. The integrated unit may be implemented in a form of hardware, or may be implemented in a form of a software function unit.

When the integrated unit is implemented in a form of a software function unit and sold or used as an independent product, the integrated unit may be stored in a computer-readable storage medium. Based on such an understanding, the technical solutions of the present disclosure essentially, or all or some of the technical solutions may be implemented in a form of a software product. The computer software product is stored in a storage medium and includes several instructions for instructing a computer device (which may be a personal computer, a server, or a network device) or a processor (processor) to perform all or some of the steps of the methods described in embodiments of the present disclosure. The foregoing storage medium includes any medium that can store program code, such as a USB flash drive, a removable hard disk, a read-only memory (Read-Only Memory, ROM), a random access memory (Random Access Memory, RAM), a magnetic disk, or an optical disc.

Based on the foregoing embodiments, an embodiment of this application further provides a computer program. When the computer program is run on a computer, the computer is enabled to perform any of the methods provided in the foregoing embodiments.

Based on the foregoing embodiments, an embodiment of this application further provides a computer-readable storage medium. The computer-readable storage medium stores a computer program. When the computer program is executed by a computer, the computer is enabled to perform the any of the methods provided in the foregoing embodiments. The storage medium may be any usable medium that can be accessed by a computer. By way of example and not limitation, the computer-readable medium may include a RAM, a ROM, an EEPROM, a CD-ROM or another optical disk storage, a magnetic disk storage medium or another magnetic storage device, or any other medium that can be used to carry or store expected program code in a form of an instruction or a data structure and that can be accessed by a computer.

Based on the foregoing embodiments, an embodiment of the present disclosure further provides a chip. The chip is configured to read a computer program stored in a memory, to implement any of the methods provided in the foregoing embodiments.

Based on the foregoing embodiments, an embodiment of the present disclosure provides a chip system. The chip system includes a processor, configured to support a computer apparatus in implementing functions related to communication devices in the foregoing embodiments. In a possible design, the chip system further includes a memory, and the memory is configured to store a program and data that are necessary for the computer apparatus. The chip system may include a chip, or may include a chip and another discrete component.

A person skilled in the art should understand that embodiments of the present disclosure may be provided as a method, a system, or a computer program product. Therefore, the present disclosure may be in a form of a hardware-only embodiment, a software-only embodiment, or an embodiment combining software and hardware aspects. In addition, the present disclosure may be in a form of a computer program product implemented on one or more computer-usable storage media (including but not limited to a magnetic disk memory, a CD-ROM, an optical memory, and the like) including computer-usable program code.

The present disclosure is described with reference to the flowcharts and/or block diagrams of the method, the device (system), and the computer program product according to the present disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of another programmable data processing device to generate a machine, so that the instructions executed by a computer or a processor of another programmable data processing device generate an apparatus for implementing a specific function in one or more processes in the flowcharts and/or in one or more blocks in the block diagrams.

These computer program instructions may alternatively be stored in a computer-readable memory that can indicate a computer or another programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

These computer program instructions may alternatively be loaded onto a computer or another programmable data processing device, so that a series of operations and steps are performed on the computer or the another programmable device, to generate computer-implemented processing. Therefore, the instructions executed on the computer or the another programmable device provide steps for implementing a specific function in one or more processes in the flowcharts and/or in one or more blocks in the block diagrams.

It is clear that a person skilled in the art may make various modifications and variations to the present disclosure without departing from the protection scope of the present disclosure. Thus, the present disclosure is intended to cover these modifications and variations, provided that they fall within the scope of the claims of the present disclosure and their equivalent technologies.

1. A method comprising:
transmitting a first-stage downlink control information (DCI) indicating at least one of a sensing operation or a communication operation to be scheduled; and
transmitting a second-stage DCI for scheduling the at least one of the sensing operation or the communication operation.

2. The method of claim 1, wherein the first-stage DCI indicates at least one of following information for the at least one of the sensing operation or the communication operation:
at least one carrier frequency band;
a duplex mode;
at least one component carrier associated with at least one channel bandwidth;
at least one subcarrier spacing to be used;
an antenna configuration;
a frequency resource assignment for the second-stage DCI;
a time resource assignment for the second-stage DCI;
a physical downlink control channel (PDCCH) in a control resource set (CORESET) for carrying the second-stage DCI;
at least one reference frequency domain location;
at least one reference time location;
at least one sensing type;
a transmission or reception direction in the sensing operation;
a set of reserved time or frequency resources;
a resource reservation period;
a demodulation reference signal (DMRS) pattern for the communication operation;
a sensing signal waveform for the sensing operation;
a sensing sequence configuration;
a DCI format of the second-stage DCI;
a number of at least one DMRS port;
an antenna port configuration;
a modulation and coding scheme (MCS);
an MCS table;
one of the sensing operation or the communication operation for which rate matching is to be performed in case of resource usage conflict between the sensing operation and the communication operation; or
at least one quasi co-located (QCLed) reference signal (RS).

3. The method of claim 2, wherein two or more bits in the first-stage DCI indicate the at least one of the sensing operation or the communication operation to be scheduled, a first combination of values of the two or more bits indicates the sensing operation to be scheduled, a second combination of values of the two or more bits indicates the communication operation to be scheduled, and a third combination of values of the two or more bits indicates both the sensing operation and the communication operation to be scheduled.

4. The method of claim 3, wherein further combinations of values of the two or more bits indicate at least one of:
system information update;
a type of warning;
a skipping notification on a message;
a priority indication on resource usage for at least one of the sensing operation or the communication operation;
a quasi-collocated reference signal;
a transceiver type;
a switching indication of the transceiver type;
an activation indication of configured or reserved resource usage; or
a de-activation indication of the configured or reserved resource usage.

5. The method of claim 1, wherein the second-stage DCI indicates at least one of following information for the at least one of the sensing operation or the communication operation:
at least one carrier frequency band;
a duplex mode;
at least one component carrier associated with at least one channel bandwidth;
at least one subcarrier spacing to be used;
an antenna configuration;
a frequency resource assignment;
a time resource assignment;
at least one reference frequency domain location;
at least one reference time location;
at least one sensing type;
a transmission or reception direction in the sensing operation;
a set of reserved time or frequency resources;
a resource reservation period;
a DMRS pattern for the communication operation;
a sensing signal waveform for the sensing operation;
a sensing sequence configuration;
a number of at least one DMRS port;
an antenna port configuration;
an MCS;
an MCS table;
one of the sensing operation or the communication operation for which rate matching is to be performed in case of resource usage conflict between the sensing operation and the communication operation;
at least one QCLed RS;
a time hopping pattern;
a frequency hopping pattern;
a hybrid automatic repeat request (HARQ) process identity (ID);
a new data indicator;
more sensing operations are required;
at least one redundancy version for communication;
at least one repeatable sensing resource and pattern;
at least one zone ID;
a communication range requirement;
a sensing range requirement;
a priority of resource usage of one of the sensing operation or the communication operation in case of the resource usage conflict between the sensing operation and the communication operation;
rate matching for one of the sensing operation or the communication operation;
a request for channel state information (CSI) report; or
a cast type.

6. A method comprising:
receiving a first-stage downlink control information (DCI) indicating that at least one of a sensing operation or a communication operation is to be scheduled; and
receiving a second-stage DCI for scheduling the at least one of the sensing operation or the communication operation.

7. The method of claim 6, wherein the first-stage DCI indicates at least one of following information for the at least one of the sensing operation or the communication operation:
at least one carrier frequency band;
a duplex mode;
at least one component carrier associated with at least one channel bandwidth;
at least one subcarrier spacing to be used;
an antenna configuration;
a frequency resource assignment for the second-stage DCI;
a time resource assignment for the second-stage DCI;
a physical downlink control channel (PDCCH) in a control resource set (CORESET) for carrying the second-stage DCI;
at least one reference frequency domain location;
at least one reference time location;
at least one sensing type;
a transmission or reception direction in the sensing operation;
a set of reserved time or frequency resources;
a resource reservation period;
a demodulation reference signal (DMRS) pattern for the communication operation;
a sensing signal waveform for the sensing operation;
a sensing sequence configuration;
a DCI format of the second-stage DCI;
a number of at least one DMRS port;
an antenna port configuration;
a modulation and coding scheme (MCS);
an MCS table;
one of the sensing operation or the communication operation for which rate matching is to be performed in case of resource usage conflict between the sensing operation and the communication operation; or
at least one quasi co-located (QCLed) reference signal (RS).

8. The method of claim 7, wherein two or more bits in the first-stage DCI indicate the at least one of the sensing operation or the communication operation to be scheduled, a first combination of values of the two or more bits indicates the sensing operation to be scheduled, a second combination of values of the two or more bits indicates the communication operation to be scheduled, and a third combination of values of the two or more bits indicates both the sensing operation and the communication operation to be scheduled.

9. The method of claim 8, wherein further combinations of values of the two or more bits indicate at least one of:
system information update;
a type of warning;
a skipping notification on a message;
a priority indication on resource usage for at least one of the sensing operation or the communication operation;
a quasi-collocated reference signal;
a transceiver type;
a switching indication of the transceiver type;
an activation indication of configured or reserved resource usage; or
a de-activation indication of the configured or reserved resource usage.

10. The method of claim 6, wherein the second-stage DCI indicates at least one of following information for the at least one of the sensing operation or the communication operation:
at least one carrier frequency band;
a duplex mode;
at least one component carrier associated with at least one channel bandwidth;
at least one subcarrier spacing to be used;
an antenna configuration;
a frequency resource assignment;
a time resource assignment;
at least one reference frequency domain location;
at least one reference time location;
at least one sensing type;
a transmission or reception direction in the sensing operation;
a set of reserved time or frequency resources;
a resource reservation period;
a DMRS pattern for the communication operation;
a sensing signal waveform for the sensing operation;
a sensing sequence configuration;
a number of at least one DMRS port;
an antenna port configuration;
an MCS;
an MCS table;
an indication of one of the sensing operation or the communication operation for which rate matching is to be performed in case of resource usage conflict between the sensing operation and the communication operation;
at least one QCLed RS;
a time hopping pattern;
a frequency hopping pattern;
a hybrid automatic repeat request (HARQ) process identity (ID);
a new data indicator;
more sensing operations are required;
at least one redundancy version for communication;
at least one repeatable sensing resource and pattern;
at least one zone ID;
a communication range requirement;
a sensing range requirement;
a priority of resource usage of one of the sensing operation or the communication operation in case of the resource usage conflict between the sensing operation and the communication operation;
rate matching for one of the sensing operation or the communication operation;
a request for channel state information (CSI) report; or
a cast type.

11. An apparatus comprising:
at least one processor; and
memory coupled to the at least one processor and storing instructions that, when executed by the at least one processor, cause the apparatus to perform operations including:
transmitting a first-stage downlink control information (DCI) indicating at least one of a sensing operation or a communication operation to be scheduled; and
transmitting a second-stage DCI for scheduling the at least one of the sensing operation or the communication operation.

12. The apparatus of claim 11, wherein the first-stage DCI indicates at least one of following information for the at least one of the sensing operation or the communication operation:
at least one carrier frequency band;
a duplex mode;
at least one component carrier associated with at least one channel bandwidth;
at least one subcarrier spacing to be used;
an antenna configuration;
a frequency resource assignment for the second-stage DCI;
a time resource assignment for the second-stage DCI;
a physical downlink control channel (PDCCH) in a control resource set (CORESET) for carrying the second-stage DCI;
at least one reference frequency domain location;
at least one reference time location;
at least one sensing type;
a transmission or reception direction in the sensing operation;
a set of reserved time or frequency resources;
a resource reservation period;
a demodulation reference signal (DMRS) pattern for the communication operation;
a sensing signal waveform for the sensing operation;
a sensing sequence configuration;
a DCI format of the second-stage DCI;
a number of at least one DMRS port;
an antenna port configuration;
a modulation and coding scheme (MCS);
an MCS table;
one of the sensing operation or the communication operation for which rate matching is to be performed in case of resource usage conflict between the sensing operation and the communication operation; or
at least one quasi co-located (QCLed) reference signal (RS).

13. The apparatus of claim 12, wherein two or more bits in the first-stage DCI indicate the at least one of the sensing operation or the communication operation to be scheduled, a first combination of values of the two or more bits indicates the sensing operation to be scheduled, a second combination of values of the two or more bits indicates the communication operation to be scheduled, and a third combination of values of the two or more bits indicates both the sensing operation and the communication operation to be scheduled.

14. The apparatus of claim 13, wherein further combinations of values of the two or more bits indicate at least one of:
system information update;
a type of warning;
a skipping notification on a message;
a priority indication on resource usage for at least one of the sensing operation or the communication operation;
a quasi-collocated reference signal;
a transceiver type;
a switching indication of the transceiver type;
an activation indication of configured or reserved resource usage; or
a de-activation indication of the configured or reserved resource usage.

15. The apparatus of claim 11, wherein the second-stage DCI indicates at least one of following information for the at least one of the sensing operation or the communication operation:
at least one carrier frequency band;
a duplex mode;
at least one component carrier associated with at least one channel bandwidth;
at least one subcarrier spacing to be used;
an antenna configuration;
a frequency resource assignment;
a time resource assignment;
at least one reference frequency domain location;
at least one reference time location;
at least one sensing type;
a transmission or reception direction in the sensing operation;
a set of reserved time or frequency resources;
a resource reservation period;
a DMRS pattern for the communication operation;
a sensing signal waveform for the sensing operation;
a sensing sequence configuration;
a number of at least one DMRS port;
an antenna port configuration;
an MCS;
an MCS table;
an indication of one of the sensing operation or the communication operation for which rate matching is to be performed in case of resource usage conflict between the sensing operation and the communication operation;
at least one QCLed RS;
a time hopping pattern;
a frequency hopping pattern;
a hybrid automatic repeat request (HARQ) process identity (ID);
a new data indicator;
more sensing operations are required;
at least one redundancy version for communication;
at least one repeatable sensing resource and pattern;
at least one zone ID;
a communication range requirement;
a sensing range requirement;
a priority of resource usage of one of the sensing operation or the communication operation in case of the resource usage conflict between the sensing operation and the communication operation;
rate matching for one of the sensing operation or the communication operation;
a request for channel state information (CSI) report; or
a cast type.

16. An apparatus comprising:
at least one processor; and
memory coupled to the at least one processor and storing instructions that, when executed by the at least one processor, cause the apparatus to perform operations including:
receiving a first-stage downlink control information (DCI) indicating that at least one of a sensing operation or a communication operation is to be scheduled; and
receiving a second-stage DCI for scheduling the at least one of the sensing operation or the communication operation.

17. The apparatus of claim 16, wherein the first-stage DCI indicates at least one of following information for the at least one of the sensing operation or the communication operation:
at least one carrier frequency band;
a duplex mode;
at least one component carrier associated with at least one channel bandwidth;
at least one subcarrier spacing to be used;
an antenna configuration;
a frequency resource assignment for the second-stage DCI;
a time resource assignment for the second-stage DCI;
a physical downlink control channel (PDCCH) in a control resource set (CORESET) for carrying the second-stage DCI;
at least one reference frequency domain location;
at least one reference time location;
at least one sensing type;
a transmission or reception direction in the sensing operation;
a set of reserved time or frequency resources;
a resource reservation period;
a demodulation reference signal (DMRS) pattern for the communication operation;
a sensing signal waveform for the sensing operation;
a sensing sequence configuration;
a DCI format of the second-stage DCI;
a number of at least one DMRS port;
an antenna port configuration;
a modulation and coding scheme (MCS);
an MCS table;
one of the sensing operation or the communication operation for which rate matching is to be performed in case of resource usage conflict between the sensing operation and the communication operation; or
at least one quasi co-located (QCLed) reference signal (RS).

18. The apparatus of claim 17, wherein two or more bits in the first-stage DCI indicate the at least one of the sensing operation or the communication operation to be scheduled, a first combination of values of the two or more bits indicates the sensing operation to be scheduled, a second combination of values of the two or more bits indicates the communication operation to be scheduled, and a third combination of values of the two or more bits indicates both the sensing operation and the communication operation to be scheduled.

19. The apparatus of claim 18, wherein further combinations of values of the two or more bits indicate at least one of:
system information update;
a type of warning;
a skipping notification on a message;
a priority indication on resource usage for at least one of the sensing operation or the communication operation;
a quasi-collocated reference signal;
a transceiver type;
a switching indication of the transceiver type;
an activation indication of configured or reserved resource usage; or
a de-activation indication of the configured or reserved resource usage.

20. The apparatus of claim 16, wherein the second-stage DCI indicates at least one of following information for the at least one of the sensing operation or the communication operation:
at least one carrier frequency band;
a duplex mode;
at least one component carrier associated with at least one channel bandwidth;
at least one subcarrier spacing to be used;
an antenna configuration;
a frequency resource assignment;
a time resource assignment;
at least one reference frequency domain location;
at least one reference time location;
at least one sensing type;
a transmission or reception direction in the sensing operation;
a set of reserved time or frequency resources;
a resource reservation period;
a DMRS pattern for the communication operation;
a sensing signal waveform for the sensing operation;
a sensing sequence configuration;
a number of at least one DMRS port;
an antenna port configuration;
an MCS;
an MCS table;
an indication of one of the sensing operation or the communication operation for which rate matching is to be performed in case of resource usage conflict between the sensing operation and the communication operation;
at least one QCLed RS;
a time hopping pattern;
a frequency hopping pattern;
a hybrid automatic repeat request (HARQ) process identity (ID);
a new data indicator;
more sensing operations are required;
at least one redundancy version for communication;
at least one repeatable sensing resource and pattern;
at least one zone ID;
a communication range requirement;
a sensing range requirement;
a priority of resource usage of one of the sensing operation or the communication operation in case of the resource usage conflict between the sensing operation and the communication operation;
rate matching for one of the sensing operation or the communication operation;
a request for channel state information (CSI) report; or
a cast type.
